(19) United States
(12) Patent Application Publication
(10) Pub. No.: US 2026/0292696 A1
(43) Pub. Date: Sep. 24, 2026

(54) MODULATION SCHEMES FOR CHIRP-BASED WAKEUP SIGNALS

(71) Applicant: QUALCOMM Incorporated, San Diego, CA (US)

(72) Inventors: Zhikun WU, Beijing (CN); Wei YANG, San Diego, CA (US); Peter GAAL, San Diego, CA (US); Huilin XU, Temecula, CA (US); Yuchul KIM, San Diego, CA (US)

(21) Appl. No.: 19/473,756

(22) PCT Filed: May 11, 2023
(86) PCT No.: PCT/CN2023/093456

§ 371 Date: Oct. 8, 2025

(51) Int. Cl. H04W 52/02; H04L 27/04

(52) U.S. Cl. CPC H04W 52/0235; H04L 27/04

(57) ABSTRACT

Methods, systems, and devices for wireless communication are described. A device may modulate a set of information bits using on-off keying (OOK), or frequency shift keying (FSK), or both. The device may generate awake-up signal (WUS) waveform using a chirp signal and the modulated set of information bits. The device may transmit the WUS waveform via at least a portion of a WUS bandwidth and a portion of a WUS time duration. The WUS waveform may occupy at least the portion of the WUS bandwidth and at least the portion of the WUS time duration in accordance with a pattern that is based on the modulated set of information bits.

### CROSS REFERENCE

The present Application for Patent is a 371 national phase filing of International Patent Application No. PCT/CN2023/093456 by WU et al., entitled “MODULATION SCHEMES FOR CHIRP-BASED WAKEUP SIGNALS,” filed May 11, 2023, assigned to the assignee hereof, and expressly incorporated by reference herein.

### FIELD OF TECHNOLOGY

The present disclosure relates to wireless communication, including modulation schemes for chirp-based wakeup signals (WUSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network nodes, each supporting wireless communication for communication devices, which may be known as user equipment (UE). To reduce power consumption, these communication devices may support low-power wakeup signals (LP-WUS). In some cases, existing modulation techniques for LP-WUSs may be deficient.

### SUMMARY

The described techniques relate to improved methods, systems, devices, and apparatuses that support modulation schemes for chirp-based wakeup signals (WUSs). For example, the described techniques provide a framework for generating a WUS waveform using a chirp signal with on-off keying (OOK), or frequency shift keying (FSK), or both. In some examples, a device (e.g., a user equipment (UE), a network node) may modulate a set of information bits using OOK, or FSK, or both. The device may generate the WUS waveform using the chirp signal and the modulated set of information bits. The device may transmit the WUS waveform via at least a portion of a WUS bandwidth and a portion of a WUS time duration. In some examples, the WUS waveform may occupy at least the portion of the WUS bandwidth and at least the portion of the WUS time duration in accordance with a pattern that is based on the modulated set of information bits.

A method for wireless communications at a device is described. The method may include modulating a set of information bits using OOK, or FSK, or both, generating a WUS waveform using a chirp signal and the modulated set of information bits, and transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

An apparatus for wireless communications at a device is described. The apparatus may include at least one memory and at least one processor coupled to the at least one memory. The at least one processor may be configured to modulate a set of information bits using OOK, or FSK, or both, generate a WUS waveform using a chirp signal and the modulated set of information bits, and transmit the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Another apparatus for wireless communications at a device is described. The apparatus may include means for modulating a set of information bits using OOK, or FSK, or both, means for generating a WUS waveform using a chirp signal and the modulated set of information bits, and means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

A non-transitory computer-readable medium storing code for wireless communications at a device is described. The code may include instructions executable by at least one processor to modulate a set of information bits using OOK, or FSK, or both, generate a WUS waveform using a chirp signal and the modulated set of information bits, and transmit the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Some examples of the method, apparatuses, and non-transitory computer-readable medium described herein may further include operations, features, means, or instructions for transmitting or receiving a control message indicating a WUS scheme that identifies OOK, or FSK, or both, and identifies the pattern, where modulating the set of information bits may be based on the control message and the WUS waveform may be transmitted in accordance with the pattern.

Some examples of the method, apparatuses, and non-transitory computer-readable medium described herein may further include operations, features, means, or instructions for transmitting or receiving a control message indicating a WUS scheme that identifies one or more parameters associated with generation of the WUS waveform, where generating the WUS waveform may be based on the control message.

Some examples of the method, apparatuses, and non-transitory computer-readable medium described herein may further include operations, features, means, or instructions for transmitting or receiving a control message indicating a WUS scheme that identifies the WUS bandwidth and the WUS time duration, where generating the WUS waveform may be based on the control message.

In some examples of the method, apparatuses, and non-transitory computer-readable medium described herein, the WUS waveform occupies the WUS bandwidth and the portion of the WUS time duration and the portion of the WUS time duration occupied by the WUS waveform indicates a bit value for a first bit of the set of information bits in accordance with the pattern.

In some examples of the method, apparatuses, and non-transitory computer-readable medium described herein, the WUS waveform occupies the portion of the WUS bandwidth and the WUS time duration and the portion of the WUS bandwidth occupied by the WUS waveform indicates a bit value for a first bit of the set of information bits in accordance with the pattern.

In some examples of the method, apparatuses, and non-transitory computer-readable medium described herein, the WUS waveform occupies the portion of the WUS bandwidth and the portion of the WUS time duration and the portion of the WUS bandwidth and the portion of the WUS time duration indicate at least a first bit value for a first bit of the set of information bits in accordance with the pattern.

In some examples of the method, apparatuses, and non-transitory computer-readable medium described herein, the portion of the WUS bandwidth and the portion of the WUS time duration occupied by the WUS waveform indicate the first bit value for the first bit and a second bit value for a second bit of the set of information bits in accordance with the pattern.

In some examples of the method, apparatuses, and non-transitory computer-readable medium described herein, a first portion of the WUS waveform occupies the portion of the WUS bandwidth and the portion of the WUS time duration to indicate a first value for a first bit of the set of information bits in accordance with the pattern, and a second portion of the WUS waveform occupies a second portion of the WUS bandwidth and a second portion of the WUS time duration to indicate a second value for a second bit of the set of information bits in accordance with the pattern.

In some examples of the method, apparatuses, and non-transitory computer-readable medium described herein, the chirp signal includes a monotone frequency signal with a slope that increases or decreases linearly over time.

In some examples of the method, apparatuses, and non-transitory computer-readable medium described herein, at least the pattern, or the slope, or both, indicate a first value for a first bit of the set of information bits.

In some examples of the method, apparatuses, and non-transitory computer-readable medium described herein, the slope indicates the first value for the first bit of the set of information bits and the pattern indicates a second value for a second bit of the set of information bits.

In some examples of the method, apparatuses, and non-transitory computer-readable medium described herein, the first value for the first bit may be based on a frequency offset associated with the chirp signal, a value of the slope, or whether the slope increases or decreases linearly over time, or any combination thereof.

In some examples of the method, apparatuses, and non-transitory computer-readable medium described herein, the chirp signal includes a non-linear chirp signal.

Some examples of the method, apparatuses, and non-transitory computer-readable medium described herein may further include operations, features, means, or instructions for obtaining a time domain sample sequence based on sampling the WUS waveform within at least the portion of the WUS bandwidth and the portion of the WUS time duration, applying a transform to the time domain sample sequence to generate a frequency domain sample sequence, and generating an orthogonal frequency division multiplexing (OFDM) waveform based on mapping the frequency domain sample sequence to a set of multiple resource elements, where the WUS waveform may be the OFDM waveform.

In some examples of the method, apparatuses, and non-transitory computer-readable medium described herein, the chirp signal includes a Zadoff Chu sequence.

In some examples of the method, apparatuses, and non-transitory computer-readable medium described herein, the WUS waveform may be a low-power WUS (LP-WUS) waveform.

A method for wireless communications at a device is described. The method may include monitoring a WUS bandwidth and a WUS time duration for a WUS waveform indicative of a set of information bits, receiving, based on the monitoring, the WUS waveform via at least a portion of the WUS bandwidth and a portion of the WUS time duration, where the WUS waveform is based on a chirp signal and OOK, or FSK, or both, of the set of information bits, and transitioning from a first state to a second state based on receiving the WUS waveform.

An apparatus for wireless communications at a device is described. The apparatus may include at least one memory and at least one processor coupled to the at least one memory. The at least one processor may be configured to monitor a WUS bandwidth and a WUS time duration for a WUS waveform indicative of a set of information bits, receive, based on the monitoring, the WUS waveform via at least a portion of the WUS bandwidth and a portion of the WUS time duration, where the WUS waveform is based on a chirp signal and OOK, or FSK, or both, of the set of information bits, and transition from a first state to a second state based on receiving the WUS waveform.

Another apparatus for wireless communications at a device is described. The apparatus may include means for monitoring a WUS bandwidth and a WUS time duration for a WUS waveform indicative of a set of information bits, means for receiving, based on the monitoring, the WUS waveform via at least a portion of the WUS bandwidth and a portion of the WUS time duration, where the WUS waveform is based on a chirp signal and OOK, or FSK, or both, of the set of information bits, and means for transitioning from a first state to a second state based on receiving the WUS waveform.

A non-transitory computer-readable medium storing code for wireless communications at a device is described. The code may include instructions executable by at least one processor to monitor a WUS bandwidth and a WUS time duration for a WUS waveform indicative of a set of information bits, receive, based on the monitoring, the WUS waveform via at least a portion of the WUS bandwidth and a portion of the WUS time duration, where the WUS waveform is based on a chirp signal and OOK, or FSK, or both, of the set of information bits, and transition from a first state to a second state based on receiving the WUS waveform.

Some examples of the method, apparatuses, and non-transitory computer-readable medium described herein may further include operations, features, means, or instructions for transmitting or receiving a control message indicating a WUS scheme that identifies OOK, or FSK, or both, where receiving the WUS waveform may be based on the control message.

Some examples of the method, apparatuses, and non-transitory computer-readable medium described herein may further include operations, features, means, or instructions for transmitting or receiving a control message indicating a WUS scheme that identifies one or more parameters associated with generation of the WUS waveform, where receiving the WUS waveform may be based on the control message.

Some examples of the method, apparatuses, and non-transitory computer-readable medium described herein may further include operations, features, means, or instructions for transmitting or receiving a control message indicating a WUS scheme that identifies the WUS bandwidth and the WUS time duration, where monitoring the WUS bandwidth and the WUS time duration may be based on the control message.

Some examples of the method, apparatuses, and non-transitory computer-readable medium described herein may further include operations, features, means, or instructions for decoding the WUS waveform to obtain the set of information bits.

Some examples of the method, apparatuses, and non-transitory computer-readable medium described herein may further include operations, features, means, or instructions for performing a de-chirp operation, or a filtering operation, or both, where decoding the WUS waveform may be based on the de-chirp operation, or the filtering operation, or both.

Some examples of the method, apparatuses, and non-transitory computer-readable medium described herein may further include operations, features, means, or instructions for identifying a correlation between the WUS waveform and a first type of chirp signal or a second type of chirp signal, where decoding the WUS waveform may be based on the correlation.

In some examples of the method, apparatuses, and non-transitory computer-readable medium described herein, the WUS waveform occupies the WUS bandwidth and the portion of the WUS time duration and the portion of the WUS time duration occupied by the WUS waveform indicates a bit value for a first bit of the set of information bits in accordance with a pattern.

In some examples of the method, apparatuses, and non-transitory computer-readable medium described herein, the WUS waveform occupies the portion of the WUS bandwidth and the WUS time duration and the portion of the WUS bandwidth occupied by the WUS waveform indicates a bit value for a first bit of the set of information bits in accordance with a pattern.

In some examples of the method, apparatuses, and non-transitory computer-readable medium described herein, the WUS waveform occupies the portion of the WUS bandwidth and the portion of the WUS time duration and the portion of the WUS bandwidth and the portion of the WUS time duration indicate at least a first bit value for a first bit of the set of information bits in accordance with a pattern.

In some examples of the method, apparatuses, and non-transitory computer-readable medium described herein, the portion of the WUS bandwidth and the portion of the WUS time duration occupied by the WUS waveform indicates the first bit value for the first bit and a second bit value for a second bit of the set of information bits in accordance with the pattern.

In some examples of the method, apparatuses, and non-transitory computer-readable medium described herein, a first portion of the WUS waveform occupies the portion of the WUS bandwidth and the portion of the WUS time duration to indicate a first value for a first bit of the set of information bits in accordance with a pattern, and a second portion of the WUS waveform occupies a second portion of the WUS bandwidth and a second portion of the WUS time duration to indicate a second value for a second bit of the set of information bits in accordance with the pattern.

In some examples of the method, apparatuses, and non-transitory computer-readable medium described herein, the chirp signal includes a monotone frequency signal with a slope that increases or decreases linearly.

In some examples of the method, apparatuses, and non-transitory computer-readable medium described herein, at least a pattern associated with the WUS waveform, or the slope, or both, indicate a first value for a first bit of the set of information bits.

In some examples of the method, apparatuses, and non-transitory computer-readable medium described herein, the slope indicates the first value for the first bit of the set of information bits and the pattern indicates a second value for a second bit of the set of information bits.

In some examples of the method, apparatuses, and non-transitory computer-readable medium described herein, the first value for the first bit may be based on a frequency offset associated with the chirp signal, a value of the slope, or whether the slope increases or decreases linearly over time, or any combination thereof.

In some examples of the method, apparatuses, and non-transitory computer-readable medium described herein, the chirp signal includes a non-linear chirp signal.

In some examples of the method, apparatuses, and non-transitory computer-readable medium described herein, the WUS waveform may be an OFDM waveform.

In some examples of the method, apparatuses, and non-transitory computer-readable medium described herein, the chirp signal includes a Zadoff Chu sequence.

In some examples of the method, apparatuses, and non-transitory computer-readable medium described herein, the WUS waveform may be an LP-WUS waveform.

### BRIEF DESCRIPTION OF THE DRAWINGS

FIGS. 1 and 2 each show an example of a wireless communications system that supports modulation schemes for chirp-based wakeup signals (WUSs) in accordance with one or more aspects of the present disclosure.

FIGS. 4 through 9, 10A, 10B, 11A, and 11B shows examples of WUS waveform diagrams that supports modulation schemes for chirp-based WUSs in accordance with one or more aspects of the present disclosure.

FIG. 12 shows an example of a waveform generation procedure that supports modulation schemes for chirp-based WUSs in accordance with one or more aspects of the present disclosure.

FIG. 13 shows an example of a process flow that supports modulation schemes for chirp-based WUSs in accordance with one or more aspects of the present disclosure.

FIGS. 14 and 15 show block diagrams of devices that support modulation schemes for chirp-based WUSs in accordance with one or more aspects of the present disclosure.

FIG. 16 shows a block diagram of a communications manager that supports modulation schemes for chirp-based WUSs in accordance with one or more aspects of the present disclosure.

FIG. 17 shows a diagram of a system including a UE that supports modulation schemes for chirp-based WUSs in accordance with one or more aspects of the present disclosure.

FIG. 18 shows a diagram of a system including a network entity that supports modulation schemes for chirp-based WUSs in accordance with one or more aspects of the present disclosure.

FIGS. 19 and 20 show flowcharts illustrating methods that support modulation schemes for chirp-based WUSs in accordance with one or more aspects of the present disclosure.

### DETAILED DESCRIPTION

Some wireless communications systems may support low-power wireless devices. As described herein, a low-power device may refer to a device that is capable of detecting signals with a relatively low received power. For example, a low-power device may include an ambient internet of things (IoT) device or another type of user equipment (UE) that may be capable of detecting signals with a relatively low received power. Signals with relatively low received powers may include low-power wakeup signals (LP-WUSs). For example, a low-power device may operate in an idle mode and may use LP-WUSs for paging reception while operating in the idle mode. In such an example, detection of an LP-WUS may trigger the low-power device to transition from the idle mode to an active mode.

In some examples, however, the low-power device may be incapable of detecting one or more types of waveforms, such as orthogonal frequency division multiplexing (OFDM) waveforms, or waveforms with relatively high sampling rates (e.g., a sampling rate larger than a system bandwidth), or both. Additionally, or alternatively, the low-power device may lack a mechanism for obtaining relatively accurate timing or frequency tracking, or both. As such, a transmitting device to the low-power device may use amplitude shift keying (ASK), such as an ON-OFF keying (OOK), or frequency shift keying (FSK) modulation to generate an LP-WUS. For example, the transmitting device may generate the LP-WUS using an OOK modulation scheme or an FSK modulation scheme, or both. In such an example, the LP-WUS may include an OOK waveforms, an FSK waveform, or an OOK with FSK waveform (e.g., an OOK/FSK waveform). In some examples, an OOK/FSK waveform may be a single-carrier OOK/FSK or a multi-carrier OOK/FSK. In some examples, the low-power device may be capable of detecting a single-carrier OOK/FSK waveform with a relatively low sampling rate. In such examples, however, the single-carrier OOK/FSK waveform may be relatively sensitive to frequency selective signal fading, which may impact a performance of the low-power device (e.g., the device receiving the single-carrier OOK/FSK waveform). A multi-carrier OOK/FSK waveform (e.g., an OOK/FSK waveform that occupy multiple subcarriers in the frequency domain) may be relatively robust against frequency selective signal fading. However, a relatively low sampling rate may not be suitable for detection of the multi-carrier OOK/FSK waveform. That is, to obtain a suitable quantity of energy from multi-carrier OOK/FSK waveforms, the multi-carrier OOK/FSK waveforms may be sampled with a rate that is proportional to a bandwidth spanned by the multi-carrier OOK/FSK waveforms. Such sampling rates may not be supported by the low-power device.

In some examples, to reduce frequency selective fading, the transmitting device may use an OFDM-based OOK/FDM waveform to generate an LP-WUS. For example, the transmitting device may generate OOK waveforms or FSK waveforms, or both, that are compatible with OFDM waveforms (e.g., OFDM signals). In some examples, however, OFDM-based OOK waveforms and OFDM-based FSK waveforms may also necessitate relatively high sampling rates and use of relatively low sampling rates (which may be supported by the low-power device) may lead to reduced performance.

Various aspects of the present disclosure relate to modulation schemes for chirp-based WUSs and, more specifically, to a framework for generating a WUS waveform using a chirp signal with OOK, or FSK, or both. For example, such techniques may enable a transmitting device to generate an LP-WUS waveform based on a chirp signal. In some examples, the transmitting device may modulate a set of information bits using OOK, or FSK, or both. The transmitting device may generate a WUS waveform (e.g., the LP-WUS waveform) using a chirp signal and the modulated set of information bits. The transmitting device may transmit the WUS waveform via at least a portion of a WUS bandwidth and a portion of a WUS time duration. In some examples, the WUS waveform may occupy at least the portion of the WUS bandwidth and at least a portion of the time duration in accordance with a pattern. The pattern may be based on the modulated set of information bits. For example, the portion of the WUS bandwidth and the portion of the time duration (e.g., an OFDM symbol) occupied by the WUS waveform may be based on a respective value of one or more bits indicated via the WUS waveform. In some examples, a low-power device, such as an ambient IoT device, may detect the WUS waveform. In response, the low-power device may transition from an idle mode to an active mode, such that the low-power device may communicate with the transmitting device (e.g., the device that transmitted the LP-WUS).

Aspects of the subject matter described herein may be implemented to realize one or more of the following potential advantages. For example, the techniques employed by the described communication devices may provide benefits and enhancements to the operation of the communication devices, including enabling chirp-based LP-WUSs. The operations performed by the described communication devices may lead to improved performance and reduced power consumption at low-power devices. In some examples, operations performed by the described communication devices may also support increased reliability of communications within a wireless communications system, among other benefits. Aspects of the disclosure are initially described in the context of wireless communications systems. Aspects if the disclosure are also described in the context of WUS waveform diagrams, a waveform generation procedure, and a process flow. Aspects of the disclosure are further illustrated by and described with reference to apparatus diagrams, system diagrams, and flowcharts that relate to modulation schemes for chirp-based WUSs.

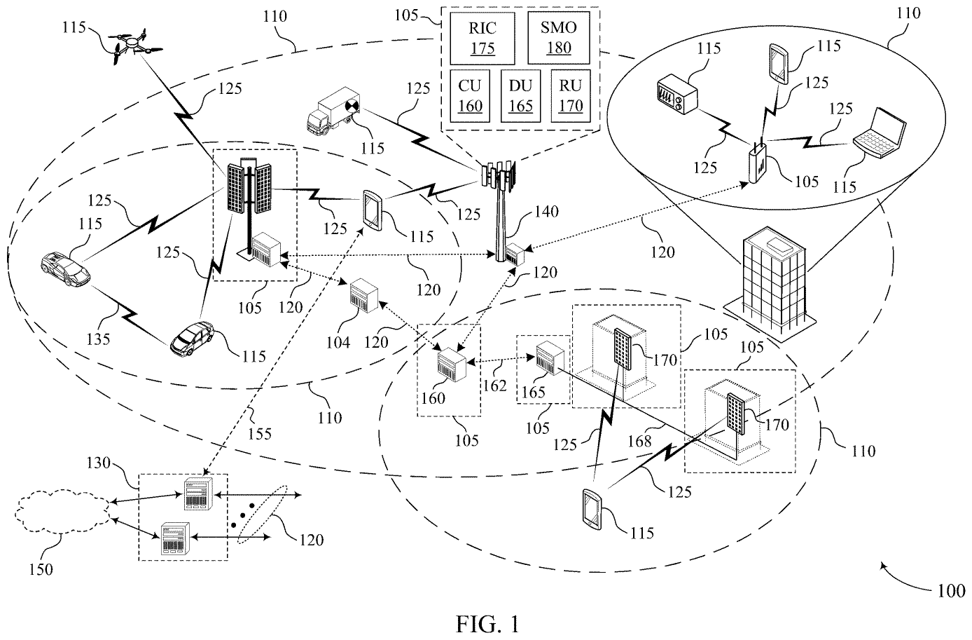

FIG. 1 shows an example of a wireless communications system 100 that supports modulation schemes for chirp-based WUSs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support modulation schemes for chirp-based WUSs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some examples of the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support low-power wireless devices, such as ambient IoT devices or other types UEs 115 that may be capable of detecting signals with a relatively low received power. For example, the wireless communications system 100 may support a low-power device that may operate in an idle mode and may use LP-WUSs for paging reception while operating in the idle mode. In some examples, a transmitter to the low-power device, such as a network entity 105 or another UE 115, may use OOK or FSK modulation to generate an LP-WUS. For example, the transmitter may generate the LP-WUS using an OOK modulation scheme or an FSK modulation scheme, or both. In such an example, the LP-WUS may include an OOK waveform, an FSK waveform, or an OOK/FSK waveform, such as a single-carrier OOK/FSK or a multi-carrier OOK/FSK. A single-carrier OOK/FSK waveform may be detected with a relatively low sampling rate. However, the single-carrier OOK/FSK waveform may be relatively sensitive to frequency selective signal fading, which may impact a performance of the low-power device (e.g., the device receiving the single-carrier OOK/FSK waveform). Additionally, while a multi-carrier OOK/FSK waveform may be relatively robust against frequency selective signal fading, a relatively low sampling rate may not be suitable for detection of the multi-carrier OOK/FSK waveform. In some examples, to reduce frequency selective fading, the transmitting device may use an OFDM-based OOK/FDM waveform to generate an LP-WUS. In some examples, however, OFDM-based OOK waveforms and OFDM-based FSK waveforms may also necessitate relatively high sampling rates and use of relatively low sampling rates (which may be supported by the low-power device) may lead to reduced performance.

In some examples, the wireless communications system 100 may support a framework for generating a WUS waveform using a chirp signal with OOK, or FSK, or both. For example, such techniques may enable a transmitting device to generate an LP-WUS waveform based on a chirp signal. In some examples, the transmitting device (e.g., a UE 115, a network entity 105) may modulate a set of information bits using OOK, or FSK, or both. The transmitting device may generate a WUS waveform (e.g., the LP-WUS waveform) using a chirp signal and the modulated set of information bits. The transmitting device may transmit the WUS waveform via at least a portion of a WUS bandwidth and a portion of a WUS time duration. In some examples, the WUS waveform may occupy at least the portion of the WUS bandwidth and at least a portion of the time duration in accordance with a pattern. The pattern may be based on the modulated set of information bits. For example, the portion of the WUS bandwidth and the portion of the time duration (e.g., an OFDM symbol) occupied by the WUS waveform may be based on a respective value of one or more bits indicated via the WUS waveform. In some examples, a low-power device (e.g., a UE 115, such as an ambient IoT device), may detect the WUS waveform. In response, the low-power device may transition from an idle mode to an active mode, such that the low-power device may communicate with the transmitting device (e.g., the device that transmitted the LP-WUS). In some examples, by transmitting the WUS waveform using the chirp signal, the transmitting device may improve a performance and reduced power consumption at the low-power device, among other benefits.

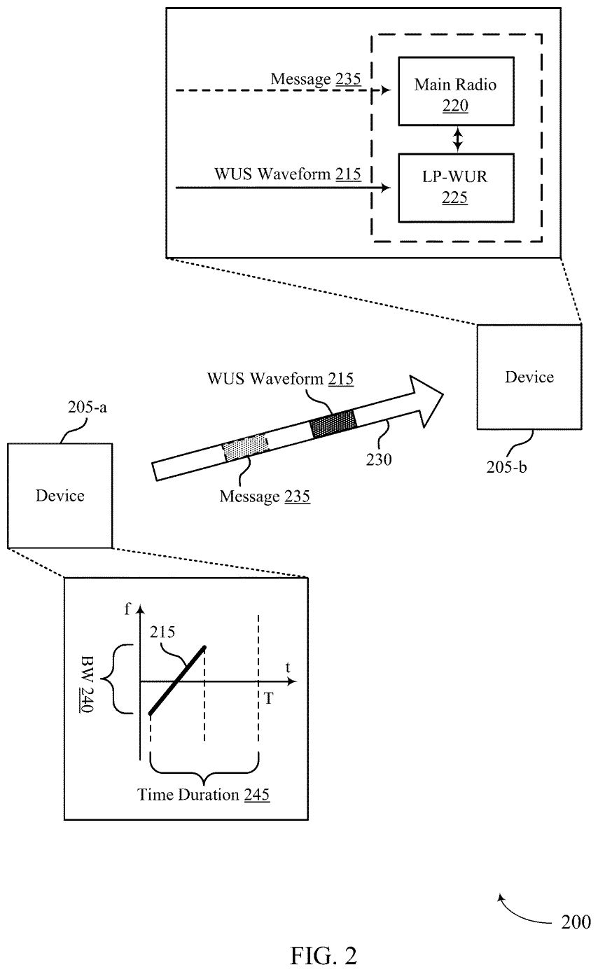

FIG. 2 shows an example of a wireless communications system 200 that supports modulation schemes for chirp-based WUSs in accordance with one or more aspects of the present disclosure. The wireless communications system 200 may implement or be implemented at one or more aspects of the wireless communications system 100. For example, the wireless communications system 200 may include a device 205-a and a device 205-b. The device 205-a may be an example of a UE 115 or a network entity 105 (e.g., a CU, a DU, an RU, a base station, an IAB node, or one or more other network nodes) illustrated by and described with reference to FIG. 1. Additionally, the device 205-b may be an example of a UE 115 illustrated by and described with reference to FIG. 1. The device 205-a may communicate with the device 205-b via a communication link 230, which may be an example of a communication link 125 (e.g., an access link, a Uu interface) or a communication link 135 (e.g., a D2D link, a PC5 interface) illustrated by and described with reference to FIG. 1.

The wireless communications system 200 may support zero or near-zero-power wireless devices (e.g., receivers, transmitters), as well as other lower power devices, such as the device 205-b. For example, the device 205-b may be capable of detecting one or more types of signals (e.g., waveforms) detectable by relatively low-power devices. That is, the device 205-b may be capable of detecting signals with a relatively low received power. For example, the device 205-b be an example of an ambient IoT device or another type of UE that may be capable of detecting signals with a relatively low received power. In other words, relatively low-power signals may be useful for ambient IoT devices. In some examples, the device 205-b may support reception of signals with a relatively low received power via a low-power wakeup radio (LP-WUR). For example, the device 205-b may be configured with main radio 220 that may be coupled with an LP-WUR 225. The LP-WUR 225 may be capable of detecting signals with a relatively low receive power (e.g., due to an unconventional radio receiver design). In some examples, the LP-WUR 225 may be capable of detecting one or more types of WUSs, such as a low-power WUS (LP-WUS). In such examples, the device 205-b may use the LP-WUR 225 for paging reception during the idle mode. For example, the device 205-a may transmit an LP-WUS to wakeup the device 205-b (e.g., to trigger the device 205-b to transition from an idle mode to an active mode). For example, the LP-WUR 225 may be coupled with (e.g., paired with) the main radio 220. As such, the device 205-b may determine to transition from a first state (e.g., the idle mode or a low-power mode) a second state (e.g., the active mode) in response to detecting an LP-WUS via the LP-WUR 225. In such an example, the LP-WUS may indicates a page (e.g., that the device 205-a or another device has data to transmit to the device 205-b). In other words, the device 205-b may use the LP-WUR 225 to monitor for paging signals during the idle mode and may transition from the idle mode to the active mode (e.g., and communicate via the main radio 220) in response to detecting an LP-WUS via the LP-WUR 225. In some examples, using the LP-WUR 225 for paging reception (or reception of other types of low-power signals) may consume less power at the device 205-b than using the main radio 220. That is, using the LP-WUR 225 to detect signals transmitted from the device 205-a may consume less power at the device 205-b than using the main radio 220 to detect signals transmitted from the device 205-a. As such, using the LP-WUR 225 (e.g., for reception of LP-WUSs) may enable the device 205-b to conserve power.

In some examples, however, the device 205-b may be incapable of detecting one or more types of waveforms (e.g., signals). For example, the device 205-b may be unable to detect OFDM signals, or signals with relatively high sampling rates (e.g., a sampling rate of a detectable signal may be smaller than a system bandwidth), or both. Additionally, or alternatively, the device 205-b may lack a mechanism for obtaining relatively accurate timing or frequency tracking, or both. In some other examples, the device 205-b may be capable of detecting a type of LP-WUS that may be based on an OOK modulation scheme or an FSK modulation scheme, or both. For example, the device 205-b may use the LP-WUR 225 to detect an LP-WUS generated using an OOK modulation scheme (e.g., an ASK modulation scheme) or an FSK modulation scheme, or both. That is, for some LP-WUS applications, an LP-WUS (e.g., an LP-WUS waveform) may include OOK and FSK. In other words, the device 205-b may be capable of detecting OOK waveforms, FSK waveforms, or OOK with FSK waveforms (OOK/FSK waveforms). As such, a waveform for an LP-WUS may include an OOK waveform, or an FSK waveform, or both. In some examples, an OOK/FSK waveform may be a single-carrier OOK/FSK or a multi-carrier OOK/FSK. For example, the device 205-a may transmit an LP-WUS using a single-carrier OOK/FSK waveform to the device 205-b. In such an example, the device 205-b may detect the single-carrier OOK/FSK waveform (e.g., the LP-WUS) with a relatively small sampling rate (e.g., about a 30 kHz sampling at 30 kHz SCS). In some examples, however, single-carrier OOK/FSK waveforms may be relatively sensitive to frequency selectivity (e.g., frequency selective signal fading), which may impact a performance of the LP-WUS. Additionally, or alternatively, the device 205-a may transmit an LP-WUS using a multi-carrier OOK/FSK waveform (e.g., a waveform that occupies multiple subcarriers in the frequency domain). In such examples, the LP-WUS may be relatively robust against frequency selective signal fading. In some examples, however, multi-carrier OOK/FSK waveforms may necessitate relatively high sampling rate (e.g., sampling rates proportional to a total bandwidth spanned by the LP-WUS), which may not be supported by the device 205-b. In other words, multi-carrier OOK/FSK waveforms may be associated with relatively high sampling rates, which may not be supported by the low-power device. Additionally, while single-carrier OOK/FSK waveforms may be associated with relatively small sampling rates, single-carrier OOK/FSK waveforms may be sensitive to frequency selective fading.

To reduce frequency selective fading, the device 205-a may use an OFDM-based OOK/FDM waveform. For example, the device 205-a may generate OOK signals or FSK signals, or both, that are compatible with other OFDM signals. In some examples, the device 205-a may generate such signals for an LP-WUS. That is, the device 205-a may use OOK waveforms or FSK waveforms, or both, that are compatible with other OFDM signals for LP-WUSs. In other words, both OFDM compatible FSK and OFDM compatible OOK waveforms may be used for LP-WUSs. For example, an OOK waveform may correspond to an waveform with an ON state (e.g., an ON duration) in which the amplitude of the wave is non-zero and an OFF state (e.g., an OFF duration) in which the amplitude of the wave is zero (or nearly zero). In such an example, the ON state (e.g., the duration in which the amplitude of the waveform is non-zero) may represent a first bit value (e.g., a binary 1). Additionally, the OFF state (e.g., the duration in which the amplitude of the waveform is zero) may represent a second bit value (e.g., a binary 0). In some examples, an FSK waveform may correspond to a waveform with an ON state in which the waveform has a first frequency and an OFF state in which the waveform has a second frequency. In such an example, the ON state (e.g., the duration in which the waveform has the first frequency) may represent a first bit value (e.g., a binary 1). Additionally, the OFF state (e.g., the duration in which the waveform has the second frequency) may represent a second bit value (e.g., a binary 0). In some examples, FSK may be considered as ON-OFF in the frequency domain. In some examples, the device 205-a may generate an OFDM-based OOK signal by first generating a time-domain OOK signal (e.g., of length M), and then passing the generated OOK signal through an OFDM waveform generator, such as a DFT-S-OFDM waveform generator with an inverse fast Fourier transform (IFFT) (e.g., an M point DFT+N point IFFT waveform generator, in which N>M). In such an example, an ON duration may include a non-zero sample sequence (e.g., M/K bits with a value of 1) and an OFF duration may include a zero sample sequence (e.g., M/K bits with a value of 0). In some examples, an ON duration of the OOK sample sequence may correspond to a length of M/K samples, where M is an integer multiple of K such that each ON-OFF duration of the OOK sample sequence has a same length. In some examples, K=2^{b}, b=0, 1, 2, . . . , where b=0 may indicate an ON duration of length M. Accordingly, the OOK sample sequence may include a quantity K different ON-OFF levels (e.g., durations).

In some examples, however, OFDM-based OOK signals and OFDM-based FSK signals may necessitate relatively high sampling rates. That is, relatively high sampling rates may be used to capture a suitable quantity of the signal energy from an OFDM-based OOK/FDM waveform. For example, using an OFDM-based OOK signal, a single bit may be transmitted per OFDM symbol. In other words, 1 bit may be transmitted per OFDM symbol via OOK. In such an example, a data rate achievable by the OFDM-based OOK signal may be about 28 kilobits/second (28 kbps) for a 30 kHz SCS. To reduce frequency selective signal fading, the device 205-a may spread the spectrum of the signal by inserting random phases (e.g., random QPSK) in the ON duration (e.g., prior to passing the OOK signal through the DFT-S-OFDM waveform generator). In such examples, the device 205-a may generate an OFDM-based OOK signal with about a 4.32 MHz bandwidth (e.g., assuming the OOK signal occupies about 12 RBs in the frequency domain). In some examples, to capture a suitable quantity of signal energy from the resulting OFDM-based OOK signal, the device 205-b may sample the OFDM-based OOK signal at 4.32 MHz (or above). A relatively similar sampling rate may be used for OFDM-based FSK signals. However, the device 205-b may not support such sampling rates. For example, the device 205-b may support a sampling rate of about 2.16 MHz. In some examples, use of a lower sampling rate (e.g., about 2.16 MHz) with OFDM-based OOK signals (or OFDM-based FSK signals) may reduce performance (e.g., irrespective of the data rate of the OOK signal is being 28 kbps). In such examples, it may be desirable to generate a signal in which the bandwidth is relatively large, the receiver sampling rate is relatively small, and the signal may be detected without FFT (e.g., at the receiver, such as the device 205-b which may not support FFT operations).

In some examples, modulation schemes for chirp-based WUSs, as described herein, may provide a framework for generating a WUS waveform using a chirp signal with OOK, or FSK, or both. For example, such techniques may enable the device 205-b to generate a relatively low-power waveform based on a (OFDM compatible) chirp signal. In some examples, the device 205-a may use one or more modulation schemes for chirp-based WUSs, as described herein, to generate a chirp-based LP-WUS or other types of signals that may be detectable by ambient IoT and other low-power devices. In other words, such techniques may enable use the device 205-a to use a chirp signal (e.g., embedded in OFDM time/frequency grid, such that the chirp signal may be OFDM-compatible) combined with OOK and/or FSK to convey information for LP-WUS and other ambient IoT use cases.

For example, the device 205-a may modulate a set of information bits using OOK, or FSK, or both. The device 205-a may generate a WUS waveform 215 (e.g., an LP-WUS waveform) using a chirp signal and the modulated set of information bits. The device 205-a may transmit the WUS waveform 215 via at least a portion of a WUS bandwidth (e.g., a BW 240) and a portion of a WUS time duration (e.g., a time duration 245). In some examples, the WUS waveform 215 may occupy at least the portion of the BW 240 and at least a portion of the time duration 245 (T) in accordance with a pattern. The pattern may be based on the modulated set of information bits. For example, the portion of the BW 240 and the portion of the time duration 245 (e.g., an OFDM symbol) may be based on the modulated set of information bits (e.g., based on a respective value of one or more bits indicated via the WUS waveform 215). In some examples, the device 205-b may detect the WUS waveform 215 via the LP-WUR 225. In such examples, the device 205-b may transition from an idle mode (e.g., an idle state or low-power state) to an active mode (e.g., an active state). While operating in the active mode, the device 205-b may receive a message 235 from the device 205-b via the main radio 220. In some examples, the device 205-a may be an example of a network node. In such an example, the message 235 may be an example of a downlink message (e.g., a downlink grant scheduling downlink or uplink communications between the device 205-a and the device 205-b). In some other examples, the device 205-a may be an example of a UE. In such an example, the message 235 may be an example of a sidelink message (or an uplink message) or another type of message that may be detectable via the device 205-b. In some examples, by generating the WUS waveform 215 using the chirp signal with OOK, or FSK, or both, the WUS waveform 215 may be relatively robust against frequency selective signal fading (or interference burst). Additionally, the device 205-b may detect the WUS waveform 215 with a relatively low sampling rate (e.g., with a sampling rate proportional to the data rate rather than the total bandwidth), which may lead to improved performance, among other benefits.

FIG. 3 shows examples of WUS waveform diagrams 300 that support modulation schemes for chirp-based WUSs in accordance with one or more aspects of the present disclosure. The WUS waveform diagrams 300 (e.g., a WUS waveform diagram 300-a, a WUS waveform diagram 300-b, a WUS waveform diagram 300-c, and a WUS waveform diagram 300-d) may be implemented at one or more aspects of the wireless communications system 100 and the wireless communications system 200. For example, the WUS waveform diagram 300-a and the WUS waveform diagram 300-b may be implemented at a first device, which may be an example of a device (e.g., a UE or a network node) illustrated by and described with reference to FIGS. 1 and 2. Additionally, the WUS waveform diagram 300-c and the WUS waveform diagram 300-d may be implemented at a second device, which may be an example of a device (e.g., a UE) illustrated by and described with reference to FIGS. 1 and 2.

In some examples, the first device may generate a waveform using a chirp signal and OOK modulation. That is, the first device may support OOK masked chirp-continuous frequency WUS waveforms. For example, the first device be an example of a transmitter, which may generate a WUS waveform in accordance with the WUS waveform diagram 300-a and the WUS waveform diagram 300-b. In such an example (e.g., at the transmitter side), the first device may support using a chirp signal to generate a WUS waveform. For example, the first device may generate a WUS waveform using a chirp signal with a positive slope (e.g., a monotone linearly increasing frequency signal) or a chirp signal with a negative slope (e.g., a monotone linearly decreasing frequency signal). That is, the first device may support using a monotone linearly increasing or decreasing frequency signal.

In some examples, the first device may support using a monotone linearly increasing (or decreasing) frequency signal during at least a portion of a time duration 320. The time duration 320 may be an example of a symbol, such as a WUS symbol (e.g., an LP-WUS symbol, an OFDM symbol with 1 bit per symbol). Additionally, the first device may support using a monotone linearly increasing (or decreasing) frequency signal during at least a portion of a bandwidth (e.g., a BW 315). The BW 315 may be an example of a WUS bandwidth (e.g., an LP-WUS bandwidth, about 4.32 MHz). In some examples, the first device may be configured to use the BW 315 (or a portion of the BW 315) to for generating (e.g., transmitting) a WUS waveform. For example, the first device may receive an indication (e.g., via control signaling) of at least a portion of the BW 315 to use for generating the WUS waveform, or the first device may be otherwise configured with at least a portion of the BW 315 to use for generating the WUS waveform. Additionally, the first device may be configured with at least a portion of the time duration 320 to use for generating (e.g., transmitting) the WUS waveform. For example, the first device may receive an indication (e.g., via control signaling) of at least a portion of the time duration 320 to use for generating the WUS waveform, or the first device may be otherwise configured with at least a portion of the time duration 320 to use for generating the WUS waveform.

In some examples, the device may use OOK modulation with a chirp signal to generate the WUS waveform in accordance with a pattern. That is, the generated WUS waveform may occupy at least a portion of the BW 315 and during at least a portion of the time duration 320 in accordance with a pattern. In such examples, the WUS waveform may include the chirp signal (e.g., a monotone linearly increasing (or decreasing) frequency signal). In other words, the first device may use OOK modulation with the chirp signal, such that a portion of the chirp signal (e.g., half of the chirp, the WUS waveform) in the time domain may be a monotone linearly increasing (or decreasing) frequency signal and a remaining portion of the chirp signal (e.g., the other half of the chirp signal) may be empty. That is, during at least one of a portion 325-a and a portion 325-b the chirp signal may be non-empty (and include the WUS waveform) and during a remaining portion (e.g., the other of the portion 325-a and the portion 325-b) the chirp signal may be empty. In other words, the non-empty portion of the chirp signal (e.g., the WUS waveform) may be referred to as a non-empty sub-chirp. In some examples, each non-empty sub-chirp may occupy at least a portion (e.g., one, or half, or 1/M) of the time duration 320. That is, each WUS waveform may occupy at least a portion (e.g., one, or half, or 1/M) of the time duration 320. In some examples, the time duration 320 (T) may correspond to 1 OFDM symbol duration (e.g., about 33 microseconds, excluding a cyclic prefix (CP)). In such examples, each non-empty sub-chirp may occupy one OFDM symbol duration, half of an OFDM symbol duration, or 1/M of an OFDM symbol duration (e.g., in which M is an integer greater than 2). That is, each WUS waveform may occupy one OFDM symbol duration, half of an OFDM symbol duration, or 1/M of an OFDM symbol duration (e.g., in which M is an integer greater than 2).

In some examples, a location of a WUS waveform may indicate a value of a bit. In other words, a location of a non-empty sub-chirp may indicate a value of a bit. That is, different non-empty sub-chirp locations (in time domain) may convey different information (e.g., bit 0 vs bit 1). For example, the first device may modulate a set of information bits using OOK. The first device may then generate the WUS waveform using the modulated set of information bits and a chirp signal. In such an example, a location of the WUS waveform in time (e.g., all or a portion of the time duration 320) and a location of the WUS waveform in frequency (e.g., all or a portion of the BW 315) may be in accordance with a pattern that is based on the modulated set of information bits.

The WUS waveform diagram 300-a illustrates a WUS waveform 310-a (e.g., a non-empty sub-chirp) that occupies the portion 325-a of the time duration 320 and occupies the BW 315. In such an example, the WUS waveform 310-a may indicate a bit with a value of 0 (e.g., may indicate bit 0). That is, in accordance with the pattern for a bit with a value of 0, the WUS waveform 310-a may be located within the portion 325-a and the BW 315. In such an example, the WUS waveform 310-a (chirp₀(t)) may be described in accordance with the following Equation 1: E

$$Tx : {chirp}_{0} ( t ) = \{ \begin{matrix}{e}^{j 2 π t ( - \frac{BW}{2} + \frac{2 BW}{T} t )} & 0 < t < T / 2 \\ 0 & T / 2 < t < T\end{matrix} . \qquad ( 1 )$$

Additionally, the WUS waveform diagram 300-b illustrates a WUS waveform 310-b (e.g., the non-empty sub-chirp) that occupies the portion 325-b and occupies the BW 315. In such an example, the WUS waveform 310-b indicates a bit with a value of 1 (e.g., indicates bit 1). That is, in accordance with the pattern for the bit with a value of 1, the WUS waveform 310-b may be located within the portion 325-b and the BW 315. In such an example, the WUS waveform 310-b (chirp₀(t)) may be described in accordance with the following Equation 2:

$$Tx : {chirp}_{1} ( t ) = \{ \begin{matrix}0 & 0 < t < T / 2 \\ {e}^{j 2 π t ( - \frac{BW}{2} + \frac{2 BW}{T} ( t - \frac{T}{2} )} & T / 2 < t < T\end{matrix} . \qquad ( 2 )$$

In some examples, a slope of the WUS waveform 310-a or the WUS waveform 310-b may be such that the WUS waveform 310-a and the WUS waveform 310-b occupy the BW 315. In other words, the slope of the non-empty sub-chirp may be selected such that the non-empty sub-chirp occupies the BW 315 (e.g., the LP-WUS bandwidth).

In some examples, the second device may be an example of a receiver, which may monitor for a WUS waveform in accordance with the WUS waveform diagram 300-c and the WUS waveform diagram 300-d. For example, the second device may use (e.g., may be configured to use) at least a portion of the BW 315 and at least a portion of the time duration 320 to monitor for a WUS waveform. The second device may receive an indication (e.g., via control signaling) of at least a portion of the BW 315 to use for monitoring for the WUS waveform, or the second device may be otherwise configured with at least a portion of the BW 315 to use for monitoring for the WUS waveform. Additionally, the second device may use (e.g., be configured to use) at least a portion of the time duration 320 to monitor for the WUS waveform. For example, the second device may receive an indication (e.g., via control signaling) of at least a portion of the time duration 320 to use for monitoring for the WUS waveform, or the second device may be otherwise configured with at least a portion of the time duration 320 for monitoring for the WUS waveform. In such an example (e.g., at the receiver side), the second device may de-chirp a received WUS waveform, use one or more low pass filters (LPFs) to filter out baseband (BB) signals, and decode the received WUS waveform (e.g., via a decoding method, such as a decoding method for Manchester code). In some examples, the second device may use a relatively low sampling rate. That is, a sampling rate used at the second device may be relatively low, for example, due to the BB signal bandwidth after the de-chirp operation being relatively small. Accordingly, the second device may filter out the de-chirped WUS waveform using an LPF, such as an LPF with about a 3 dB bandwidth (e.g., an LPF with a bandwidth that may be less than the BW 315, an LPF with a bandwidth of hundreds of KHz).

In some examples, the second device may de-chirp a non-empty sub-chirp (e.g., a WUS waveform). For example, the second device may de-chirp WUS waveforms illustrated in the WUS waveform diagram 300-a and the WUS waveform diagram 300-b, and the resulting WUS waveform (e.g., a direct current (DC) signal) may be illustrated in the WUS waveform diagram 300-c and the WUS waveform diagram 300-d, respectively. For example, the second device may receive the WUS waveform 310-a and perform a de-chirp operation (e.g., on the WUS waveform 310-a) to obtain the WUS waveform 311-a. In such an example, the WUS waveform 311-a may indicate a bit with a value of 0 (e.g., indicates bit 0). That is, a location of the WUS waveform 311-a may be in accordance with a pattern for a bit with a value of 0. In other words, the second device may multiply the WUS waveform 310-a (described in accordance with Equation 1) by a de-chirp signal, which may be described in accordance with the following Equation 3:

$$Rx : de - chirp ( t ) = {e}^{j 2 π t ( \frac{BW}{2} - \frac{2 BW}{T} t )} \qquad ( 3 )$$

to obtain the WUS waveform 311-a. As such, the WUS waveform 311-a may be described in accordance with following Equation 4:

$$Rx : {chirp}_{0} ( t ) = \{ \begin{matrix}1 & 0 < t < T / 2 \\ 0 & T / 2 < t < T\end{matrix} . \qquad ( 4 )$$

In some other examples, the second device may receive the WUS waveform 310-b and perform a de-chirp operation (e.g., on the WUS waveform 310-b) to obtain the WUS waveform 311-b. In such an example, the WUS waveform 311-b may indicate a bit with a value of 1 (e.g., indicates bit 1). That is, a location of the WUS waveform 311-b may be in accordance with a pattern for a bit with a value of 1. In other words, the second device may multiply the WUS waveform 310-b (e.g., described in accordance with Equation 2) by the de-chirp signal (described in accordance with the Equation 3) to obtain the WUS waveform 311-b. In such an example, the WUS waveform 311-b may be described in accordance with the following Equation 5:

$$Rx : {chirp}_{1} ( t ) = \{ \begin{matrix}0 & 0 < t < T / 2 \\ 1 & T / 2 < t < T\end{matrix} . \qquad ( 5 )$$

In some examples, the second device may detect the WUS waveforms 310 with a relatively low sampling rate, which may lead to improved performance at the second device, among other benefits.

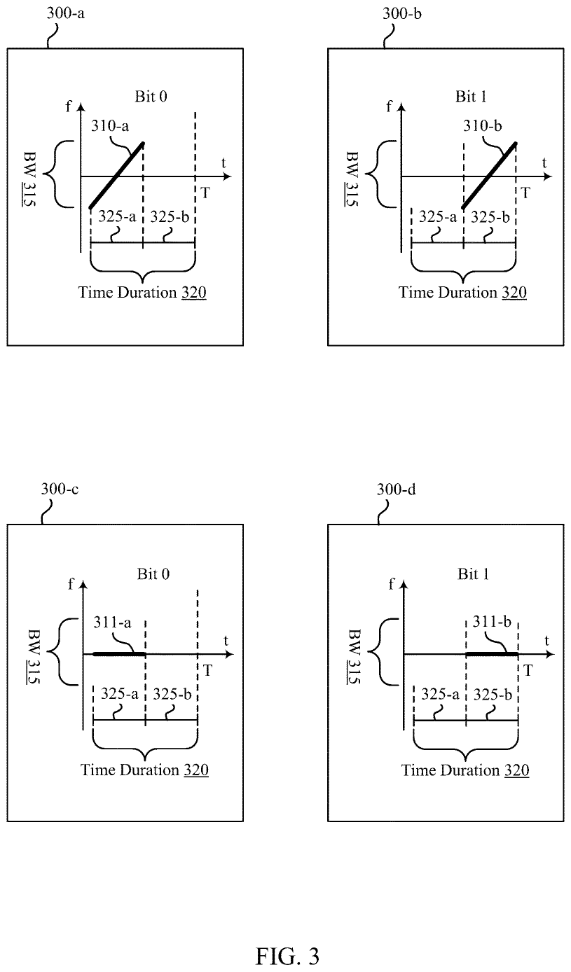

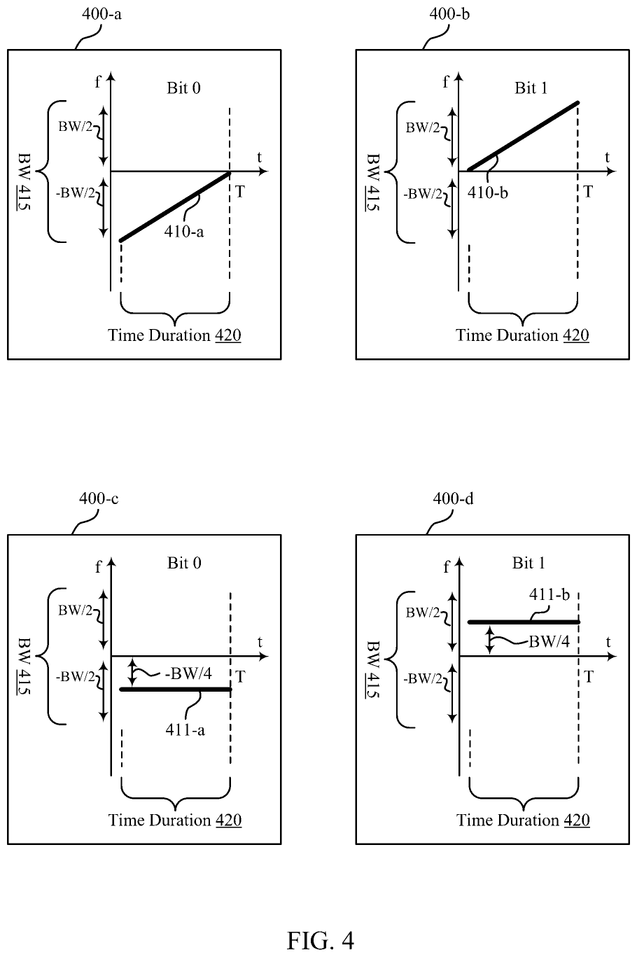

FIG. 4 shows an example of WUS waveform diagrams 400 that supports modulation schemes for chirp-based WUSs in accordance with one or more aspects of the present disclosure. The WUS waveform diagrams 400 (e.g., a WUS waveform diagram 400-a, a WUS waveform diagram 400-b, a WUS waveform diagram 400-c, and a WUS waveform diagram 400-d) may be implemented at one or more aspects of the wireless communications system 100, the wireless communications system 200, and the WUS waveform diagrams 300. For example, the WUS waveform diagram 400-a and the WUS waveform diagram 400-b may be implemented at a first device, which may be an example of a device (e.g., a UE or a network node) illustrated by and described with reference to FIGS. 1 through 3. Additionally, the WUS waveform diagram 400-c and the WUS waveform diagram 400-d may be implemented at a second device, which may be an example of a device (e.g., a UE) illustrated by and described with reference to FIGS. 1 through 3.

In some examples, the first device may generate a waveform using a chirp signal and FSK modulation. That is, the first device may support FSK-like chirp-continuous frequency WUS waveforms. For example, the first device be an example of a transmitter, which may generate a WUS waveform in accordance with the WUS waveform diagram 400-a and the WUS waveform diagram 400-b. That is, the first device may use multiple (e.g., different) chirp signals in the frequency domain to convey information. For example, the first device may generate a WUS waveform using a chirp signal with a positive slope (e.g., a monotone linearly increasing frequency signal) or a chirp signal with a negative slope (e.g., a monotone linearly decreasing frequency signal). In some examples, the first device may support using a monotone linearly increasing or decreasing frequency signal in at least a portion of a time duration 420. The time duration 420 may be an example of a symbol, such as a WUS symbol (e.g., an LP-WUS symbol (e.g., an OFDM symbol with 1 bit per symbol).

As illustrated in the example of FIG. 4, the first device may use (e.g., be configured to use) at least a portion of the time duration 420 for generating the WUS waveform. For example, the first device may receive an indication (e.g., via control signaling) of at least a portion of the time duration 420 or the first device may be otherwise configured with at least a portion of the time duration 420. Additionally, the first device may use (e.g., be configured to use) at least a portion of a BW 415 for generating a WUS waveform. For example, the first device may receive an indication (e.g., via control signaling) of at least a portion of the BW 415 or the first device may be otherwise configured with at least a portion of the BW 415 to use for generating a WUS waveform.

In some examples, the device may use FSK modulation with a chirp signal to generate the WUS waveform in accordance with a pattern. That is, the generated WUS waveform may occupy at least a portion of the BW 415 and during at least a portion of the time duration 420 in accordance with a pattern. In such examples, the WUS waveform may include the chirp signal (e.g., a monotone linearly increasing (or decreasing) frequency signal). In other words, the first device may use FSK modulation with the chirp signal, such that a portion of the chirp signal (e.g., half of the chirp signal, the WUS waveform) in the frequency domain may be a monotone linearly increasing (or decreasing) frequency signal and a remaining portion of the chirp signal (e.g., the other half of the chirp signal) may be empty. That is, during at least a portion of the BW 415 the chirp signal may be non-empty (and include the WUS waveform) and during a remaining portion of the BW 415 the chirp signal may be empty. As illustrated in the example of FIG. 4, within half of the BW 415 (e.g., one of BW/2 and −BW/2) the chirp signal may be non-empty and during the other of half of the BW 415 (e.g., the other of BW/2 and −BW/2) the chirp signal may be empty. The non-empty portion of the chirp signal may be referred to as a non-empty sub-chirp. In the example of FIG. 4, each non-empty sub-chirp may occupy at least a portion (e.g., one, or half, or 1/M) of the BW 415. For example, the BW 415 may be an example of an LP-WUS bandwidth (e.g., about 4.32 MHz) and a slope of a non-empty sub-chirp may be selected such that the non-empty sub-chirp occupies half of the LP-WUS bandwidth (e.g., LP-WUS 12 BW). In other words, each non-empty sub-chirp may occupy the time duration 420 (e.g., one OFDM symbol duration) and half of the LP-WUS bandwidth (e.g., about 2.16 MHz).

In some examples, a location of a WUS waveform may indicate a value of a bit. In other words, a location of a non-empty sub-chirp may indicate a value of a bit. That is, different non-empty sub-chirp locations (in the frequency domain) may convey different information (e.g., bit 0 vs bit 1). For example, the first device may modulate a set of information bits using FSK. The first device may then generate the WUS waveform using the modulated set of information bits and a chirp signal. In such an example, a location of the WUS waveform in time (e.g., all or a portion of the time duration 420) and a location of the WUS waveform in frequency (e.g., all or a portion of the BW 415) may be in accordance with a pattern that is based on the modulated set of information bits. In other words, whether a first half of the BW 415 (e.g., BW/2) or a second half of the BW 415 (e.g., −BW/2) is occupied by the WUS waveform (e.g., used, activated) may depend on the value of the information bit.

The WUS waveform diagram 400-a illustrates a WUS waveform 410-a (e.g., the non-empty sub-chirp) that occupies−BW/2 and occupies the time duration 420 (T). In such an example, the WUS waveform 410-a may indicate a bit with a value of 0 (e.g., indicates bit 0). That is, in accordance with the pattern for a bit with a value of 0, the WUS waveform 410-a may be located within the second half of the BW 415 (e.g., −BW/2) and within the time duration 420. In such an example, the WUS waveform 410-a (chirp₀(t)) may be described in accordance with the following Equation 6:

$$Tx : {chirp}_{0} ( t ) = {e}^{j 2 π t ( - \frac{BW}{2} + \frac{2 BW}{2 T} t )} . \qquad ( 6 )$$

Additionally, the WUS waveform diagram 400-b illustrates a WUS waveform 410-b (e.g., the non-empty sub-chirp) that occupies BW/2. In such an example, the WUS waveform 410-b may indicate a bit with a value of 1 (e.g., indicates bit 1). That is, in accordance with the pattern for a bit with a value of 1, the WUS waveform 410-b may be located within the first half of the BW 415 (e.g., BW/2) and within the time duration 420. In such an example, the WUS waveform 410-b (chirp₁(t)) may be described in accordance with the following Equation 7:

$$Tx : {chirp}_{1} ( t ) = {e}^{j 2 π t ( \frac{BW}{2 T} t )} . \qquad ( 7 )$$

In some examples, the second device may be an example of a receiver, which may monitor for a WUS waveform in accordance with the WUS waveform diagram 400-c and the WUS waveform diagram 400-d. In such an example, the second device may use (e.g., be configured to use) at least a portion of the BW 415 to monitor for the WUS waveform. For example, the second device may receive an indication (e.g., via control signaling) of at least a portion of the BW 415 to use for monitoring for the WUS waveform, or the second device may be otherwise configured with at least a portion of the BW 415 for monitoring for the WUS waveform. Additionally, the second device may use (e.g., be configured to use) at least a portion of the time duration 420 to monitor for the WUS waveform. For example, the second device may receive an indication (e.g., via control signaling) of at least a portion of the time duration 420, or the second device may be otherwise configured with at least a portion of the time duration 420 to use for monitoring for the WUS waveform. In such an example (e.g., at the receiver side), the second device may de-chirp the received WUS waveform and use one or more LPFs. For example, to determine which frequency location is used by the first device (e.g., to transmit the WUS waveform), the second device may use two LPFs, which may target multiple (e.g., different) candidate frequencies (e.g., BW/4, −BW/4). The second device may decode the received WUS waveform (e.g., via a decoding method, such as a decoding method for Manchester code). In some examples, the second device may use a relatively low sampling rate. That is, a sampling rate used at the second device may be relatively low, for example, due to the BB signal bandwidth after de-chirp being relatively small.

In some examples, the second device may de-chirp a non-empty sub-chirp (e.g., the WUS waveform). For example, the second device may de-chirp WUS waveforms illustrated in the WUS waveform diagram 400-a and the WUS waveform diagram 400-b, and the resulting signal (e.g., a DC signal) may be illustrated in the WUS waveform diagram 400-c and the WUS waveform diagram 400-d, respectively. For example, the second device may receive the WUS waveform 410-a and perform a de-chirp operation (e.g., on the WUS waveform 410-a) to obtain the WUS waveform 411-a. In such an example, the WUS waveform 411-a may indicate a bit with a value of 0 (e.g., indicates bit 0). That is, a location of the WUS waveform 411-a may be in accordance with a pattern for a bit with a value of 0. In some other examples, the second device may receive the WUS waveform 410-b and perform a de-chirp operation (e.g., on the WUS waveform 410-b) to obtain the WUS waveform 411-b. In such an example, the WUS waveform 411-b may indicate a bit with a value of 1 (e.g., indicates bit 1). That is, a location of the WUS waveform 411-b may be in accordance with a pattern for a bit with a value of 1. In some examples, the second device may detect the WUS waveforms 410 with a relatively low sampling rate, which may lead to improved performance at the second device, among other benefits.

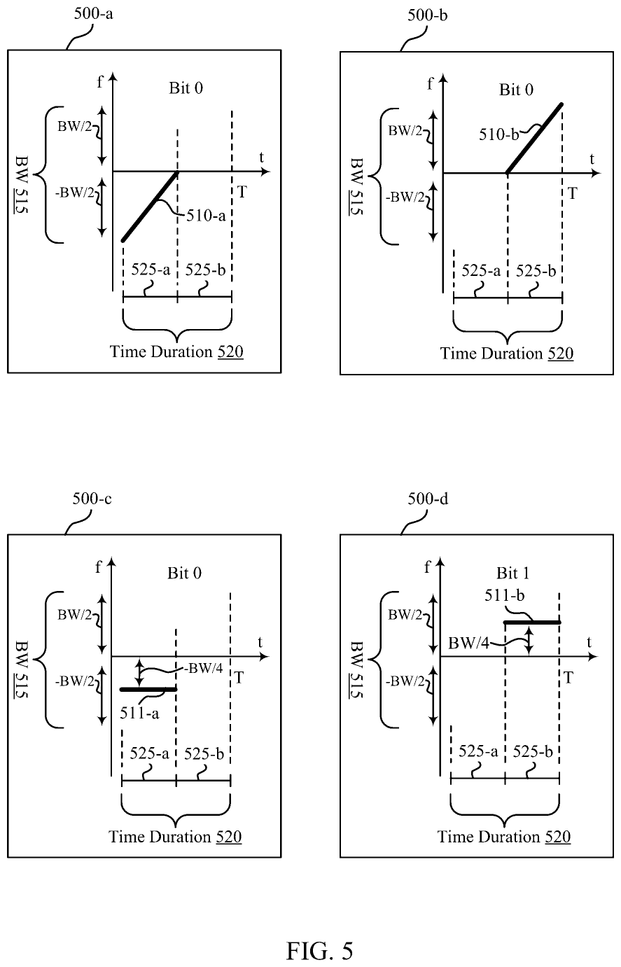

FIG. 5 show examples of WUS waveform diagrams 500 that supports modulation schemes for chirp-based WUSs in accordance with one or more aspects of the present disclosure. The WUS waveform diagrams 500 (e.g., a WUS waveform diagram 500-a, a WUS waveform diagram 500-b, a WUS waveform diagram 500-c, and a WUS waveform diagram 500-d) may be implemented at one or more aspects of the wireless communications system 100, the wireless communications system 200, the WUS waveform diagrams 300, and the WUS waveform diagrams 400. For example, the WUS waveform diagram 500-a and the WUS waveform diagram 500-b may be implemented at a first device, which may be an example of a device (e.g., a UE or a network node) illustrated by and described with reference to FIGS. 1 through 4. Additionally, the WUS waveform diagram 500-c and the WUS waveform diagram 500-d may be implemented at a second device, which may be an example of a device (e.g., a UE) illustrated by and described with reference to FIGS. 1 through 4.

In some examples, the first device may generate a waveform using a chirp signal with OOK and FSK modulation. That is, the device may support combinations of OOK and FSK masking for WUS waveforms. For example, the first device may be an example of a transmitter, which may generate a WUS waveform in accordance with the WUS waveform diagram 500-a and the WUS waveform diagram 500-b. The first device may support using a chirp signal with a positive slope (e.g., a monotone linearly increasing frequency signal) or a chirp signal with a negative slope (e.g., a monotone linearly decreasing frequency signal) to generate a WUS waveform. As illustrated in the example of FIG. 5, the first device may support using a monotone linearly increasing (or decreasing) frequency signal during at least a portion of a time duration 520. The time duration 520 may be an example of a symbol, such as a WUS symbol (e.g., an LP-WUS symbol, an OFDM symbol with 1 bit per symbol).

As illustrated in the example of FIG. 5, the first device may use (e.g., be configured to use) a at least a portion of a BW 515 for generating a WUS waveform. In some examples, the BW 515 may be an example of an LP-WUS bandwidth (e.g., about 4.32 MHz). Additionally, the first device may use (e.g., be configured to use) at least a portion of the time duration 520 for generating the WUS waveform. In some examples, the device may use OOK and FSK modulation with a chirp signal to generate the WUS waveform in accordance with a pattern. That is, the generated WUS waveform may occupy at least a portion of the BW 515 and during at least a portion of the time duration 520 in accordance with a pattern. In such examples, the WUS waveform may include the chirp signal (e.g., a monotone linearly increasing (or decreasing) frequency signal). In other words, the first device may use OOK and FSK modulation with the chirp signal, such that a portion of the chirp signal (e.g., half of the chirp signal, the WUS waveform) in the time domain may be a monotone linearly increasing (or decreasing) frequency signal and a remaining portion of the chirp signal (e.g., the other half of the chirp signal) may be empty. That is, during at least one of a portion 525-a and a portion 525-b, the chirp signal may be non-empty (e.g., and include the WUS waveform) and during a remaining portion (e.g., the other of the portion 525-a and the portion 525-b) the chirp signal may be empty. Although the example of FIG. 5 illustrates the non-empty sub-chirp (e.g., the WUS waveform) occupying half of the time duration 520 (e.g., either the portion 525-a or the portion 525-b), the non-empty sub-chirp may occupy other portions of the time duration 520, such as 0.2 of the time duration 520 or 0.8 of the time duration 520, among other examples. In some examples, a location of a WUS waveform may indicate a value of a bit. In other words, a location of a non-empty sub-chirp may indicate a value of a bit. That is, different non-empty sub-chirps (or symbols) may occupy different frequency ranges (e.g., different portions of the BW 515). In some examples, a slope of the non-empty sub-chirp (e.g., the WUS waveform) may selected such that the non-empty chirp occupies half of the BW 515 (e.g., BW/2, −BW/2). For example, the BW 515 may be an example of an LP-WUS bandwidth and the slope of the WUS waveform may be selected such that the WUS waveform occupies half of the LP-WUS bandwidth (e.g., LP-WUS ½).

In some examples, a location of a WUS waveform may indicate a value of a bit. In other words, a location of a non-empty sub-chirp may indicate a value of a bit. That is, different non-empty sub-chirp locations (in the time domain and the frequency domain) may convey different information (e.g., bit 0 vs bit 1). For example, the WUS waveform diagram 500-a illustrates a WUS waveform 510-a (e.g., the non-empty sub-chirp) that occupies the portion 525-a and −BW/2. In such an example, the WUS waveform 510-a indicates a bit with a value of 0 (e.g., indicates bit 0). That is, in accordance with the pattern for a bit with a value of 0, the WUS waveform 510-a may be located within the second half of the BW 515 (e.g., −BW/2) and within the portion 525-a of the time duration 520. In such an example, the WUS waveform 510-a (chirp₀(t)) may be described in accordance with the following Equation 8:

$$Tx : {chirp}_{0} ( t ) = \{ \begin{matrix}{e}^{j 2 π t ( - \frac{BW}{2} + \frac{BW}{T} t )} & 0 < t < T / 2 \\ 0 & T / 2 < t < T\end{matrix} . \qquad ( 8 )$$

Additionally, the WUS waveform diagram 500-b illustrates a WUS waveform 510-b (e.g., the non-empty sub-chirp) that occupies the portion 525-b and BW/2. In such an example, the WUS waveform 510-b indicates a bit with a value of 1 (e.g., indicates bit 1). That is, in accordance with the pattern for a bit with a value of 1, the WUS waveform 510-b may be located within the first half of the BW 515 (e.g., BW/2) and within the portion 525-b of the time duration 520. In such an example, the WUS waveform 510-b (chirp₁(t)) may be described in accordance with the following Equation 9:

$$Tx : {chirp}_{1} ( t ) = \{ \begin{matrix}0 & 0 < t < T / 2 \\ {e}^{j 2 π ( t - \frac{T}{2} ) ( - \frac{BW}{2} + \frac{BW}{T} ( t - \frac{T}{2} )} & T / 2 < t < T\end{matrix} . \qquad ( 9 )$$

In some examples, the second device may be an example of a receiver, which may monitor for a WUS waveform in accordance with the WUS waveform diagram 500-c and the WUS waveform diagram 500-d. In such an example, the second device may use (e.g., be configured to use) at least a portion of the BW 515 to monitor for an WUS waveform. Additionally, the second device may use (e.g., be configured to use) at least a portion of the time duration 520 to monitor for the WUS waveform. In such an example (e.g., at the receiver side), the second device may de-chirp the received WUS waveform, use one or more LPFs to filter out BB signals, and decode the received WUS waveform (e.g., via a decoding method, such as a decoding method for Manchester code). For example, the second device may use two LPFs (e.g., a first LPF at BW/4 and a second LPF at −BW/4). Additionally, or alternatively, the second device may use one or more co-relation methods to filter out BB signals. For example, the second device may use multiple (e.g., different) chirp signals to obtain a correlation between bits and chirp signals. In such an example, the second device may compare a received WUS waveform with a threshold to determine, in accordance with the obtained correlation, whether the receive WUS waveform corresponds to a chirp signal with a bit value of 0 (e.g., a chirp 0) or a chirp signal with a bit value of 1 (e.g., chirp 1). The second device may perform the correlation in RF or in BB. In some examples, the second device may use a relatively low sampling rate. That is, a sampling rate used at the second device may be relatively low, for example, due to the BB signal bandwidth after de-chirp being relatively small.

In some examples, the second device may de-chirp a non-empty sub-chirp. For example, the second device may de-chirp WUS waveforms illustrated in the WUS waveform diagram 500-a and the WUS waveform diagram 500-b, and the resulting signal (e.g., a DC signal) may be shown in the WUS waveform diagram 500-c and the WUS waveform diagram 500-d, respectively. For example, the second device may receive the WUS waveform 510-a, perform a de-chirp operation, and apply the second LPF at −BW/4 (e.g., to the WUS waveform 510-a) to obtain the WUS waveform 511-a. In such an example, the WUS waveform 511-a may indicate a bit with a value of 0 (e.g., indicates bit 0). That is, a location of the WUS waveform 511-a may be in accordance with a pattern for a bit with a value of 0. In some other examples, the second device may receive the WUS waveform 510-b, perform a de-chirp operation, and apply the first LPF at BW/4 (e.g., on the WUS waveform 510-b) to obtain the WUS waveform 511-b. In such an example, the WUS waveform 511-b may indicate a bit with a value of 1 (e.g., indicates bit 1). That is, a location of the WUS waveform 511-b may be in accordance with a pattern for a bit with a value of 1. In some examples, the second device may detect the WUS waveforms 510 with a relatively low sampling rate, which may lead to improved performance at the second device, among other benefits.

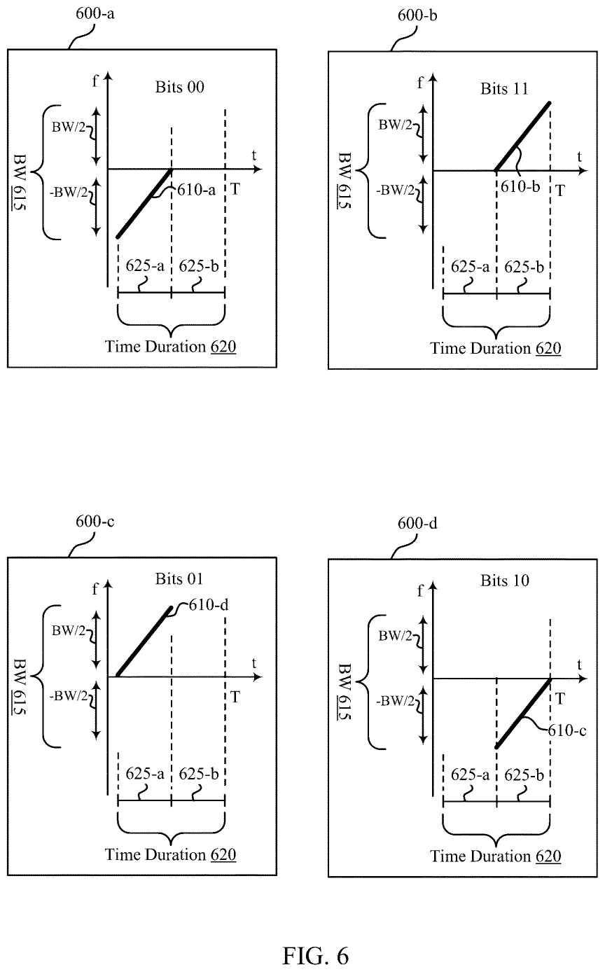

FIG. 6 shows example of WUS waveform diagrams 600 that supports modulation schemes for chirp-based WUSs in accordance with one or more aspects of the present disclosure. The WUS waveform diagrams 600 (e.g., a WUS waveform diagram 600-a, a WUS waveform diagram 600-b, a WUS waveform diagram 600-c, and a WUS waveform diagram 600-d) may be implemented at one or more aspects of the wireless communications system 100, the wireless communications system 200, the WUS waveform diagrams 300, the WUS waveform diagrams 400, and the WUS waveform diagrams 500. For example, the WUS waveform diagrams 600 may be implemented at a first device, which may be an example of a device (e.g., a UE or a network node) illustrated by and described with reference to FIGS. 1 through 5.

In some examples, the first device may generate a waveform using a chirp signal with OOK and FSK modulation. That is, the device may support combinations of OOK and FSK masking for WUS waveforms. For example, the first device may be an example of a transmitter, which may generate a WUS waveform in accordance with the WUS waveform diagrams 600. In some examples of the WUS waveform diagrams 600, multiple bits may be transmitted per WUS waveform (e.g., per pair of chirps). In some examples, a location of a WUS waveform may indicate a respective value of multiple bit. In other words, a location of a non-empty sub-chirp may indicate a respective value of multiple bits. That is, different non-empty sub-chirp locations in time, or in frequency, or both, may convey different information (e.g., bits 00, bits 01, bits 10, bits 11). For example, the first device may use PPM (pulse position modulation) combined with the chirp signal to communicate multiple (e.g., two) bits of information. In such an example, the WUS waveform may occupy a portion of a time duration 620 and a portion of a BW 615. That is, for each codepoint, a portion of the chirp signal in time and a portion of the chirp signal in frequency may be active (e.g., ¼ of the chirp signal in time and in frequency may be active).

As illustrated in the example of FIG. 6, the first device may use (e.g., be configured to use) a portion of the BW 615 for generating an WUS waveform. Additionally, the first device may use (e.g., be configured to use) a portion of the time duration 620. In some examples, the device may use OOK and FSK modulation with a chirp signal to generate the WUS waveform in accordance with a pattern. That is, the generated WUS waveform may occupy a portion of the BW 615 and during a portion of the time duration 620 in accordance with a pattern. In such examples, the WUS waveform may include the chirp signal (e.g., a monotone linearly increasing or decreasing frequency signal). In other words, the first device may use OOK and FSK modulation with the chirp signal, such that a portion of the chirp signal (e.g., half of the chirp) in the time domain and in the frequency domain may be a monotone linearly increasing (or decreasing) frequency signal and a remaining portion of the chirp signal (e.g., the other half of the chirp signal) may be empty. That is, during one of a portion 625-a and a portion 625-b the chirp signal may be non-empty and during the other of the portion 625-a and the portion 625-b the chirp signal may be empty. Although the example of FIG. 6 illustrates the non-empty sub-chirp (e.g., the WUS waveform) occupying half of the time duration 620, the non-empty sub-chirp may occupy other portions of the time duration 620, such as 0.2 of the time duration 620 or 0.8 of the time duration 620. In some examples, a location of a WUS waveform in time and in frequency may indicate a value of multiple bits. In other words, a location of a non-empty sub-chirp may indicate a value of multiple bits. That is, different non-empty sub-chirps (or symbols) may occupy different frequency ranges (e.g., different portions of the BW 615) and different time durations (e.g., either the portion 625-a or the portion 625-b) that may convey different information (e.g., bits 00, bits 11, bits 01, bits 10). In some examples, a slope of the non-empty sub-chirp (e.g., the WUS waveform) may selected such that the non-empty chirp occupies half of the BW 615 (e.g., BW/2, −BW/2) during either the portion 625-a or the portion 625-b.

For example, the WUS waveform diagram 600-a illustrates a WUS waveform 610-a (e.g., the non-empty sub-chirp) that occupies a second half of the BW 615 (e.g., −BW/2) during the portion 625-a. In such an example, the WUS waveform 610-a indicates bits with values of 00 (e.g., indicates bits 00). That is, in accordance with the pattern for bits with values of 00, the WUS waveform 610-a may be located within the second half of the BW 615 (e.g., −BW/2) and within the portion 625-a of the time duration 620. Additionally, the WUS waveform diagram 600-b illustrates a WUS waveform 610-b (e.g., the non-empty sub-chirp) that occupies a first portion of the BW 615 (e.g., BW/2) during the portion 625-b. In such an example, the WUS waveform 610-b indicates bits with values of 11 (e.g., indicates bits 11). That is, in accordance with the pattern for bits with values of 11, the WUS waveform 610-b may be located within the first half of the BW 615 (e.g., BW/2) and within the portion 625-b of the time duration 620. The WUS waveform diagram 600-c illustrates a WUS waveform 610-c (e.g., the non-empty sub-chirp) that occupies the first portion of the BW 615 (BW/2) during the portion 625-a. In such an example, the WUS waveform 610-c indicates bits with values of 01 (e.g., indicates bits 01). That is, in accordance with the pattern for bits with values of 01, the WUS waveform 610-c may be located within the first half of the BW 615 (e.g., BW/2) and within the portion 625-a of the time duration 620. The WUS waveform diagram 600-d illustrates a WUS waveform 610-d (e.g., the non-empty sub-chirp) that occupies the second portion of the BW 615 (e.g., −BW/2) during the portion 625-b. In such an example, the WUS waveform 610-d indicates bits with values of 10 (e.g., indicates bits 10). That is, in accordance with the pattern for bits with values of 10, the WUS waveform 610-d may be located within the second half of the BW 615 (e.g., −BW/2) and within the portion 625-b of the time duration 620. In some examples, a second device may detect the WUS waveforms 610 with a relatively low sampling rate, which may lead to improved performance at the second device, among other benefits.

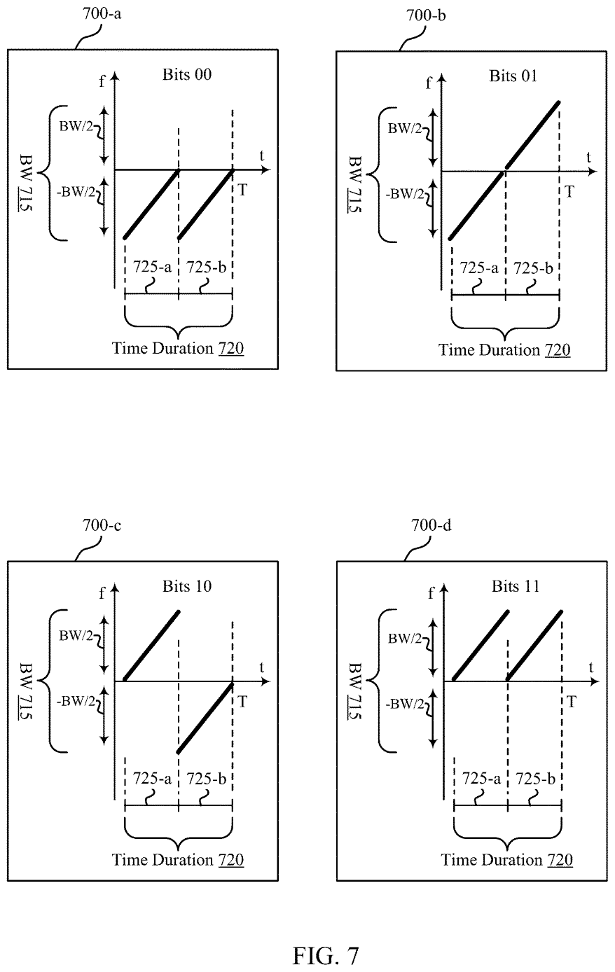

FIG. 7 shows examples of WUS waveform diagrams 700 that supports modulation schemes for chirp-based WUSs in accordance with one or more aspects of the present disclosure. The WUS waveform diagrams 700 (e.g., a WUS waveform diagram 700-a, a WUS waveform diagram 700-b, a WUS waveform diagram 700-c, and a WUS waveform diagram 700-d) may be implemented at one or more aspects of the wireless communications system 100, the wireless communications system 200, the WUS waveform diagrams 300, the WUS waveform diagrams 400, the WUS waveform diagrams 500, and the WUS waveform diagrams 600. For example, the WUS waveform diagrams 700 may be implemented at a first device, which may be an example of a device (e.g., a UE or a network node) illustrated by and described with reference to FIGS. 1 through 6.

In some examples, the first device may generate a waveform using a chirp signal with OOK and FSK modulation. That is, the device may support combinations of OOK and FSK masking for WUS waveforms. For example, the first device may be an example of a transmitter, which may generate a WUS waveform (e.g., a non-empty chirp signal) in accordance with the WUS waveform diagrams 700. In some examples of the WUS waveform diagrams 700, multiple bits may be transmitted per WUS waveform (e.g., per pair of chirps). In some examples, a location of a WUS waveform may indicate a respective value of multiple bit. In other words, a location of a non-empty sub-chirp may indicate a respective value of multiple bits. That is, different non-empty sub-chirp locations in time, or in frequency, or both, may convey different information (e.g., bits 00, bits 01, bits 10, bits 11). For example, the first device may use TDM in which a first portion of a time duration 720 (e.g., half of the time duration 720, a portion 725-a) may be used to convey a first value of a first bit, and a second portion of the time duration 720 (e.g., the other half of the time duration 720, a portion 725-b) may be used to convey a second value of a second bit. In some examples, the time duration 720 may be an example of a symbol, such as a WUS symbol (e.g., an LP-WUS symbol, an OFDM symbol with multiple bits per symbol).

As illustrated in the example of FIG. 7, the first device may use (e.g., be configured to use) at least a portion of the BW 715 for generating an WUS waveform. Additionally, the first device may use (e.g., be configured to use) the time duration 720 for generating the WUS waveform. In some examples, the device may use OOK and FSK modulation with a chirp signal to generate the WUS waveform in accordance with a pattern. That is, a first portion of the generated WUS waveform may occupy a first portion of the BW 715 during a first portion of the time duration 720 (e.g., the portion 725-a) and a second portion of the generated WUS waveform may occupy a second portion of the BW 715 during a second portion of the time duration 720 (e.g., the portion 725-b) in accordance with a pattern. In other words, the first device may use OOK and FSK modulation with the chirp signal to indicate multiple bits, such that within a first portion of the BW 715 (e.g., one of BW/2 and −BW/2) a portion of the chirp signal (e.g., half of the chirp) in the time domain may be a monotone linearly increasing (or decreasing) frequency signal in and a remaining portion of the chirp signal (e.g., the other half of the chirp signal) may be empty and within a second portion of the BW 715 (e.g., the other of BW/2 and −BW/2) another portion of the chirp signal (e.g., half of the chirp) in the time domain may be a monotone linearly increasing (or decreasing) frequency signal in and the remaining portion of the chirp signal (e.g., the other half of the chirp signal) may be empty. That is, within each of BW/2 and −BW/2, the chirp signal may be non-empty during one of a portion 725-a and a portion 725-b and empty during the other of the portion 725-a and the portion 725-b. Although the example of FIG. 7 illustrates the non-empty sub-chirp occupying half of the time duration 720, the non-empty sub-chirp may occupy other portions of the time duration 720, such as 0.2 of the time duration 720 or 0.8 of the time duration 720. Additionally, different chirps (or symbols) may occupy different frequency ranges (e.g., different portions of the BW 715).

In some examples, a location of a WUS waveform in time and in frequency may indicate a value of multiple bits. In other words, a location of a non-empty sub-chirp may indicate a value of multiple bits. That is, different combinations of non-empty sub-chirps (or symbols) may occupy different frequency ranges (e.g., different portions of the BW 715) within the portion 725-a and the portion 725-b that may convey different information (e.g., bits 00, bits 11, bits 01, bits 10). In some examples, a location of the non-empty sub-chirp (e.g., the WUS waveform) within the portion 725-a may indicate a first value of a first bit and a location of the non-empty sub-chirp within the portion 725-b may indicate a second value of a second bit. For example, the WUS waveform diagram 700-a illustrates a WUS waveform (e.g., the non-empty sub-chirp) that occupies a second portion of the BW 715 (e.g., −BW/2) during the portion 725-a and during the portion 725-b. In such an example, the portion of the WUS waveform that occurs during the portion 725-a indicates a first bit value of 0 and the portion of the WUS waveform that occurs during the portion 725-b indicates a second bit value of 0 (e.g., the WUS waveform across the time duration 720 indicates bits 00). The WUS waveform diagram 700-b illustrates a WUS waveform (e.g., the non-empty sub-chirp) that occupies the second portion of the BW 715 (e.g., −BW/2) during the portion 725-a and a first portion of the BW 715 (e.g., BW/2) during the portion 725-b. In such an example, the portion of the WUS waveform that occurs during the portion 725-a indicates a first bit value of 0 and the portion of the WUS waveform that occurs during the portion 725-b indicates a second bit value of 1 (e.g., the WUS waveform across the time duration 720 indicates bits 01). The WUS waveform diagram 700-c illustrates a WUS waveform (e.g., the non-empty sub-chirp) that occupies the first portion of the BW 715 (e.g., BW/2) during the portion 725-a and the second portion of the BW 715 (e.g., −BW/2) during the portion 725-b. In such an example, the portion of the WUS waveform that occurs during the portion 725-a indicates a first bit value of 1 and the portion of the WUS waveform that occurs during the portion 725-b indicates a second bit value of 0 (e.g., the WUS waveform across the time duration 720 indicates bits 10). The WUS waveform diagram 700-d illustrates a WUS waveform (e.g., the non-empty sub-chirp) that occupies the first portion of the BW 715 (e.g., BW/2) during the portion 725-a and during the portion 725-b. In such an example, the portion of the WUS waveform that occurs during the portion 725-a indicates a first bit value of 1 and the portion of the WUS waveform that occurs during the portion 725-b indicates a second bit value of 1 (e.g., the WUS waveform across the time duration 720 indicates bits 11).

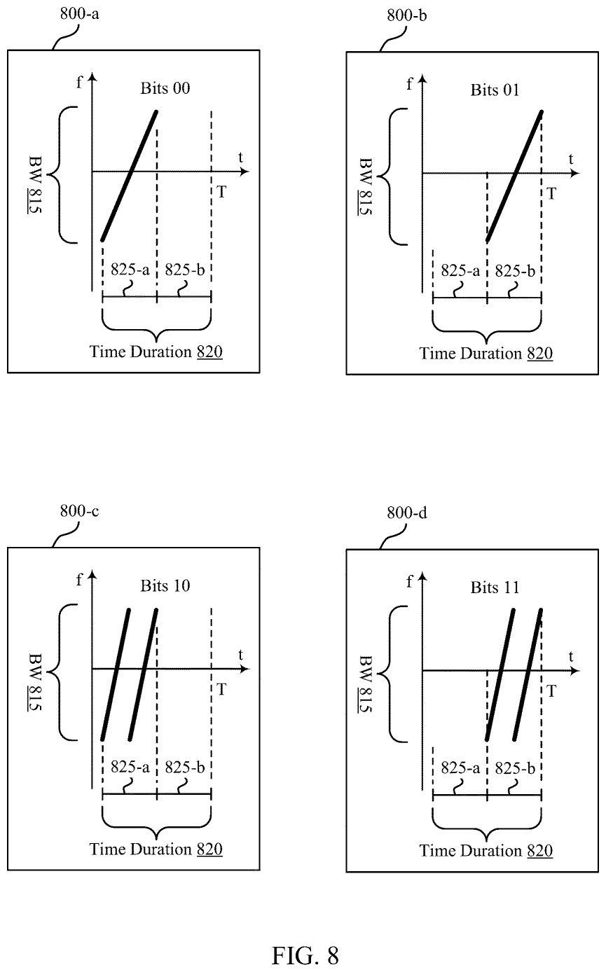

FIG. 8 shows examples of WUS waveform diagrams 800 that supports modulation schemes for chirp-based WUSs in accordance with one or more aspects of the present disclosure. The WUS waveform diagrams 800 (e.g., a WUS waveform diagram 800-a, a WUS waveform diagram 800-b, a WUS waveform diagram 800-c, and a WUS waveform diagram 800-d) may be implemented at one or more aspects of the wireless communications system 100, the wireless communications system 200, the WUS waveform diagrams 300, the WUS waveform diagrams 400, the WUS waveform diagrams 500, the WUS waveform diagrams 600, and the WUS waveform diagrams 700. For example, the WUS waveform diagrams 800 may be implemented at a first device, which may be an example of a device (e.g., a UE or a network node) illustrated by and described with reference to FIGS. 1 through 7.

In some examples, the first device may generate a waveform using a chirp signal with OOK to indicate multiple bits. For example, the first device may be an example of a transmitter, which may generate a WUS waveform (e.g., a non-empty chirp signal) in accordance with the WUS waveform diagrams 800. In some examples of the WUS waveform diagrams 800, multiple bits may be transmitted per WUS waveform. In some examples, a slope of the WUS waveform may indicate a first value of a first bit and a location of the WUS waveform in the time domain may indicate a second value of a second bit. That is, combinations of different chirp slopes may be used for multi-bit transmission. For example, the first device may use convey information via chirp by using different frequency ramping rates (i.e., slopes). In other words, a first bit may be conveyed via a slope of the non-empty chirp signal, the second bit is conveyed via a location of the non-empty chirp signal in the time domain (e.g., via OOK). For example, the first device may use (e.g., be configured to use) a BW 815 for generating an WUS waveform. Additionally, the first device may use (e.g., be configured to use) at least a portion of the time duration 820 (e.g., at least one of a portion 825-a or a portion 825-b). In some examples, the device may use OOK modulation with a chirp signal to generate the WUS waveform in accordance with a pattern. That is, the generated WUS waveform may occupy the BW 815 with a slope during a first portion of the time duration 820 (e.g., the portion 825-a) or during a second portion of the time duration 720 (e.g., the portion 725-b) in accordance with a pattern. That is, during one of the portion 825-a and the portion 825-b the chirp signal may be non-empty and have a particular slope and during the other of the portion 825-a and the portion 825-b the chirp signal may be empty. Although the example of FIG. 8 illustrates the non-empty sub-chirp occupying half of the time duration 820, the non-empty sub-chirp may occupy other portions of the time duration 820, such as 0.2 of the time duration 820 or 0.8 of the time duration 820.

In some examples, a location of the WUS waveform (e.g., non-empty sub-chirp) in the time domain may indicate a first value of a first bit and a slope of the non-empty sub-chirp may indicate a second value of a second bit. For example, the WUS waveform diagram 800-a illustrates a WUS waveform (e.g., the non-empty sub-chirp) with a first slope that occupies the BW 815 during the portion 825-a. In such an example, the first slope of the WUS waveform indicates a first bit value of 0 and the location of the WUS waveform (e.g., the WUS waveform occupying the portion 825-a) indicates a second bit value of 0 (e.g., the WUS waveform with the first slope within the portion 825-a indicates bits 00). The WUS waveform diagram 800-b illustrates a WUS waveform (e.g., the non-empty sub-chirp) with the first slope that occupies the BW 815 during the portion 825-b. In such an example, the first slope of the WUS waveform indicates a first bit value of 0 and the location of the WUS waveform (e.g., the WUS waveform occupying the portion 825-b) indicates a second bit value of 1 (e.g., the WUS waveform with the first slope within the portion 825-b indicates bits 01). The WUS waveform diagram 800-c illustrates a WUS waveform (e.g., the non-empty sub-chirp) with a second slope that occupies the BW 815 during the portion 825-a. In such an example, the second slope of the WUS waveform indicates a first bit value of 1 and the location of the WUS waveform (e.g., the WUS waveform occupying the portion 825-a) indicates a second bit value of 0 (e.g., the WUS waveform with the second slope within the portion 825-a indicates bits 10). The WUS waveform diagram 800-d illustrates a WUS waveform (e.g., the non-empty sub-chirp) with the second slope that occupies the BW 815 during the portion 825-b. In such an example, the second slope of the WUS waveform indicates a first bit value of 1 and the location of the WUS waveform (e.g., the WUS waveform occupying the portion 825-b) indicates a second bit value of 1 (e.g., the WUS waveform with the second slope within the portion 825-b indicates bits 11).

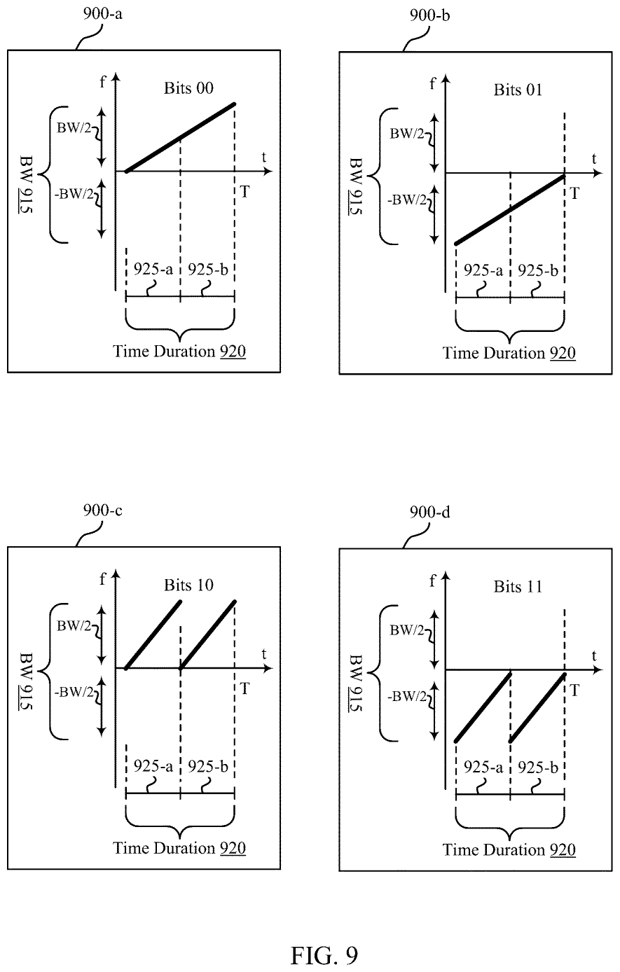

FIG. 9 shows examples of WUS waveform diagrams 900 that supports modulation schemes for chirp-based WUSs in accordance with one or more aspects of the present disclosure. The WUS waveform diagrams 900 (e.g., a WUS waveform diagram 900-a, a WUS waveform diagram 900-b, a WUS waveform diagram 900-c, and a WUS waveform diagram 900-d) may be implemented at one or more aspects of the wireless communications system 100, the wireless communications system 200, the WUS waveform diagrams 300, the WUS waveform diagrams 400, the WUS waveform diagrams 500, the WUS waveform diagrams 600, the WUS waveform diagrams 700, and the WUS waveform diagrams 800. For example, the WUS waveform diagrams 900 may be implemented at a first device, which may be an example of a device (e.g., a UE or a network node) illustrated by and described with reference to FIGS. 1 through 8.

In some examples, the first device may generate a waveform using a chirp signal with FSK to indicate multiple bits. For example, the first device may be an example of a transmitter, which may generate a WUS waveform (e.g., a non-empty chirp signal) in accordance with the WUS waveform diagrams 900. In some examples of the WUS waveform diagrams 900, multiple bits may be transmitted per WUS waveform. In some examples, a slope of the WUS waveform may indicate a first value of a first bit and a location of the WUS waveform in the frequency domain may indicate a second value of a second bit. That is, combinations of different chirp slopes may be used for multi-bit transmission. For example, the first device may use convey information via chirp by using different frequency ramping rates (i.e., slopes). In some examples, a first bit may be conveyed via a slope of the non-empty chirp signal, the second bit is conveyed via a location of the non-empty chirp signal in the frequency domain (e.g., via FSK). For example, the first device may use (e.g., be configured to use) at least a portion of BW 915 for generating an WUS waveform. Additionally, the first device may use (e.g., be configured to use) the time duration 920 for generating the WUS waveform.

In some examples, the device may use FSK modulation with a chirp signal to generate the WUS waveform in accordance with a pattern. That is, the generated WUS waveform may occupy a first portion of the BW 915 (e.g., BW/2) or a second portion of the BW 915 (e.g., −BW/2) with a slope during a first portion of the time duration 820 (e.g., the portion 825-a) and during a second portion of the time duration 720 (e.g., the portion 725-b) in accordance with a pattern. That is, during one of the first portion of the BW 915 and the second portion of the BW 915 (e.g., one of BW/2 and −BW/2) the chirp signal may be non-empty and have a particular slope and during the other of the first portion of the BW 915 and the second portion of the BW 915 (e.g., the other of BW/2 and −BW/2) the chirp signal may be empty. Although the example of FIG. 9 illustrates the non-empty sub-chirp occupying half of the BW 915, the non-empty sub-chirp may occupy other portions of the BW 915, such as 0.2 of the BW 915 or 0.8 of the BW 915, among other examples.

In some examples, by using FSK modulation, the first device may partition the chirp signal, such that a portion of the chirp signal (e.g., half of the chirp) in the frequency domain may be a monotone linearly increasing (or decreasing) frequency signal and a remaining portion (e.g., half) of the chirp signal may be empty. In some examples, a location of the WUS waveform (e.g., non-empty sub-chirp) in the frequency domain may indicate a first value of a first bit and a slope of the non-empty sub-chirp may indicate a second value of a second bit. For example, the WUS waveform diagram 900-a illustrates a WUS waveform (e.g., the non-empty sub-chirp) with a first slope that occupies the first portion of the BW 915 (e.g., BW/2) across the time duration 920. In such an example, the first slope of the WUS waveform indicates a first bit value of 0 and the location of the WUS waveform (e.g., the WUS waveform occupying BW/2) indicates a second bit value of 0 (e.g., the WUS waveform with the first slope within BW/2 indicates bits 00). The WUS waveform diagram 900-b illustrates a WUS waveform (e.g., the non-empty sub-chirp) with a first slope that occupies the second portion of the BW 915 (e.g., −BW/2) across the time duration 920. In such an example, the first slope of the WUS waveform indicates a first bit value of 0 and the location of the WUS waveform (e.g., the WUS waveform occupying BW/2) indicates a second bit value of 1 (e.g., the WUS waveform with the first slope within −BW/2 indicates bits 01). The WUS waveform diagram 900-c illustrates a WUS waveform (e.g., the non-empty sub-chirp) with a second slope that occupies the first portion of the BW 915 (e.g., BW/2) within a portion 925-a and within a portion 925-b. In such an example, the second slope of the WUS waveform indicates a first bit value of 1 and the location of the WUS waveform (e.g., the WUS waveform occupying BW/2 during the portion 925-a and the during the portion 925-b) indicates a second bit value of 0 (e.g., the WUS waveform with the second slope within BW/2 indicates bits 10). The WUS waveform diagram 900-d illustrates a WUS waveform (e.g., the non-empty sub-chirp) with a second slope that occupies the second portion of the BW 915 (e.g., −BW/2) within the portion 925-a and within the portion 925-b. In such an example, the second slope of the WUS waveform indicates a first bit value of 1 and the location of the WUS waveform (e.g., the WUS waveform occupying −BW/2 during the portion 925-a and the during the portion 925-b) indicates a second bit value of 1 (e.g., the WUS waveform with the second slope within −BW/2 indicates bits 11).

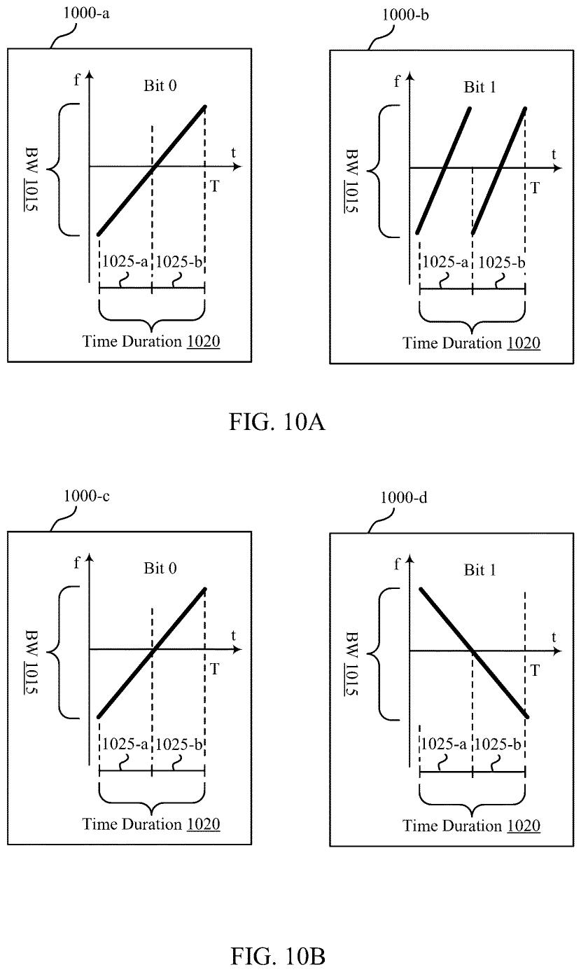

FIGS. 10A and 10B show examples of WUS waveform diagrams 1000 that supports modulation schemes for chirp-based WUSs in accordance with one or more aspects of the present disclosure. The WUS waveform diagrams 1000 (e.g., a WUS waveform diagram 1000-a, a WUS waveform diagram 1000-b, a WUS waveform diagram 1000-c, and a WUS waveform diagram 1000-d) may be implemented at one or more aspects of the wireless communications system 100, the wireless communications system 200, the WUS waveform diagrams 300, the WUS waveform diagrams 400, the WUS waveform diagrams 500, the WUS waveform diagrams 600, the WUS waveform diagrams 700, the WUS waveform diagrams 800, and the WUS waveform diagrams 900. For example, the WUS waveform diagrams 1000 may be implemented at a first device, which may be an example of a device (e.g., a UE or a network node) illustrated by and described with reference to FIGS. 1 through 9.

In some examples, the first device may generate a waveform using a chirp signal with multiple (e.g., different) slopes to indicate multiple bits. For example, the first device may be an example of a transmitter, which may generate a WUS waveform (e.g., a non-empty chirp signal) in accordance with the WUS waveform diagrams 1000. As illustrated in the example of FIG. 10A, the first device may generate the WUS waveform using multiple (e.g., different) positive slopes to indicate different bits. For example, the WUS waveform diagram 1000-a illustrates a WUS waveform (e.g., a non-empty sub-chirp) with a first slope that occupies a BW 1015 during a time duration 1020. In such an example, the first slope of the WUS waveform indicates a bit value of 0. The WUS waveform diagram 1000-b illustrates a WUS waveform (e.g., the non-empty sub-chirp) with a second slope that occupies the BW 1015 during a portion 1025-a and a portion 1025-b of the time duration 1020. In such an example, the second slope of the WUS waveform indicates a bit value of 1. Although the example of FIG. 10A illustrates the WUS waveforms being generated using multiple positive slopes, the first device may also generate the WUS waveforms using multiple (e.g., different) negative slopes.

As illustrated in the example of FIG. 10B, the first device may generate the WUS waveform using a positive or a negative slope to indicate different bits (e.g., a positive slope to indicate a value of a bit and a negative slope to indicate another value of a bit). For example, the WUS waveform diagram 1000-c illustrates a WUS waveform (e.g., a non-empty sub-chirp) with a positive slope that occupies the BW 1015 during the time duration 1020. In such an example, the positive slope of the WUS waveform indicates a bit value of 0. The WUS waveform diagram 1000-d illustrates a WUS waveform (e.g., the non-empty sub-chirp) with a negative slope that occupies the BW 1015 during the time duration 1020. In such an example, the negative slope of the WUS waveform indicates a bit value of 1.

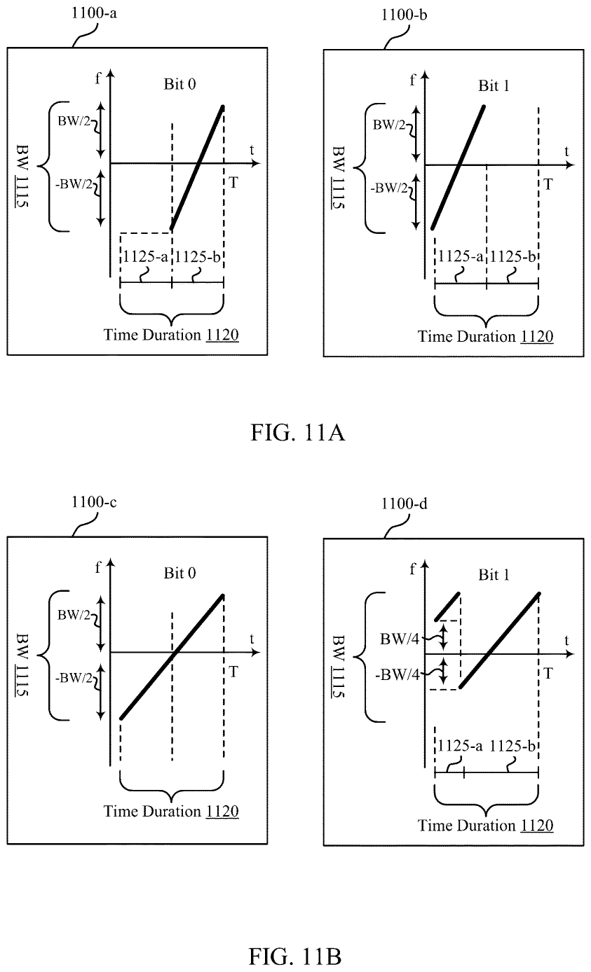

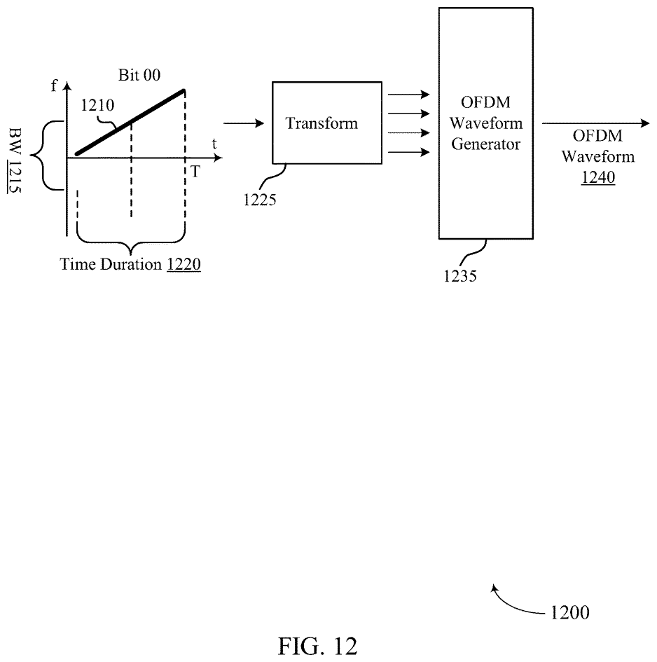

FIGS. 11A and 11B show examples of WUS waveform diagrams 1100 that supports modulation schemes for chirp-based WUSs in accordance with one or more aspects of the present disclosure. The WUS waveform diagrams 1100 (e.g., a WUS waveform diagram 1100-a, a WUS waveform diagram 1100-b, a WUS waveform diagram 1100-c, and a WUS waveform diagram 1100-d) may be implemented at one or more aspects of the wireless communications system 100, the wireless communications system 200, the WUS waveform diagrams 300, the WUS waveform diagrams 400, the WUS waveform diagrams 500, the WUS waveform diagrams 600, the WUS waveform diagrams 700, the WUS waveform diagrams 800, the WUS waveform diagrams 900, and the WUS waveform diagrams 1000. For example, the WUS waveform diagrams 1100 may be implemented at a first device, which may be an example of a device (e.g., a UE or a network node) illustrated by and described with reference to FIGS. 1 through 9, 10A, and 10B.

As illustrated in the example of FIG. 11A, the first device may generate a WUS waveform using a same slope, a same frequency range, and multiple (e.g., different) time domain patterns for different bits. For example, the WUS waveform diagram 1100-a illustrates a WUS waveform (e.g., a non-empty sub-chirp) with a slope that occupies a BW 1115 during a portion 1125-b of a time duration 1120. In such an example, the WUS waveform occupying the portion 1125-b of the time duration 1120 indicates a bit value of 0. The WUS waveform diagram 1100-b illustrates a WUS waveform (e.g., a non-empty sub-chirp) with a same slope that occupies the BW 1115 during a portion 1125-a of the time duration 1120. In such an example, the WUS waveform occupying the portion 1125-a of the time duration 1120 indicates a bit value of 1.

As illustrated in the example of FIG. 11B, the first device may generate a WUS waveform using a same slope, a same frequency range, a same time domain pattern, and multiple (e.g., different) frequency domain starting points. For example, the WUS waveform diagram 1100-c illustrates a WUS waveform (e.g., a non-empty sub-chirp) with a slope that occupies a BW 1115 during the time duration 1120 with a first frequency domain offset (e.g., a frequency domain starting point) of BW/2. That is, in accordance with the first frequency offset, the WUS waveform occupies the time duration 1120 with a frequency domain starting point of −BW/. In such an example, the WUS waveform having the first frequency domain offset indicates a bit value of 0. The WUS waveform diagram 1100-d illustrates a WUS waveform (e.g., a non-empty sub-chirp) with a same slope that occupies the BW 1115 during the time duration 1120 with a second frequency offset of BW/4. That is, in accordance with the second frequency offset, a first portion of the WUS waveform occupies the portion 1125-a of the time duration 1120 with a frequency domain starting point of BW/4 and a second portion of the WUS waveform occupies the portion 1125-b of the time duration 1120 with a frequency domain starting point of −BW/4. In such an example, the WUS waveform having the second frequency domain offset indicates a bit value of 1.

FIG. 12 shows an example of a waveform generation procedure 1200 that supports modulation schemes for chirp-based WUSs in accordance with one or more aspects of the present disclosure. The waveform generation procedure 1200 may be implemented at one or more aspects of the wireless communications system 100, the wireless communications system 200, the WUS waveform diagrams 300, the WUS waveform diagrams 400, the WUS waveform diagrams 500, the WUS waveform diagrams 600, the WUS waveform diagrams 700, the WUS waveform diagrams 800, the WUS waveform diagrams 900, the WUS waveform diagrams 1000, and the WUS waveform diagrams 1100. For example, the waveform generation procedure 1200 may be implemented at a first device, which may be an example of a device (e.g., a UE or a network node) illustrated by and described with reference to FIGS. 1 through 9, 10A, 10B, 11A, and 11B.

In some examples, the first device may use a continuous chirp signal as a base waveform to modulate OOK and FSK signals (e.g., waveforms). In some other examples, the first device may embed a chirp signal into an OFDM system to generate OFDM-compatible chirps. For example, the first device may use the OFDM system to generate OFDM-compatible chirps, which may be used for LP-WUS (e.g., to be multiplexed with other OFDM signals). Additionally, the first device may use multiple types of chirp signals, such as a linear chirp signal (e.g., a monotone linearly increasing or decreasing frequency signal) or a non-linear chirp signal (e.g., a sinusoidal chirp signal, an exponential chirp).

As illustrated in the example of FIG. 12, the first device may generate a WUS waveform 1210 using FSK and a chirp signal. The WUS waveform 1210 may occupy a time duration 1220 and at least a portion of a BW 1215. In some examples, the first device may sample the WUS waveform 215 to obtain a sample sequence that may correspond to a length of M/K samples, where M is an integer multiple of K such that each ON-OFF state of the sample sequence has a same length. In some examples, K=2^{b}, b=0, 1, 2, . . . , where b=0 may indicate an ON state of length M. Accordingly, the sample sequence may include a quantity K different ON-OFF levels (e.g., states).

In some cases, the ON state of the sample sequence may be represented as a non-zero sample sequence (e.g., bits having a value of 1) of length M/K samples. For example, the ON state may include a sample sequence having values of 1 and the OFF state may include a sample sequence having values of 0. In some examples, the sample sequence may be a Zadoff-Chu sequence. That is, the first device may implement OOK and/or FSK modulation with a Zadoff-Chu sequence (e.g., transmitted on CP-OFDM subcarriers), which may be an example of a type of chirp signal. For example, the device may use a quantity (M) of subcarriers for a WUS waveform and, as such, may determine a Zadoff-Chu sequence of length M (e.g., denoted by r̅(0), . . . , r̅(M_{ZC}−1), in which r̅(n)=x_{q}(n mod N_{ZC}) and

$${x}_{q} ( m ) = {e}^{\frac{- j π qm ( m + 1 )}{{N}_{ZC}}} ) .$$

In such an example, a slope of the resulting WUS waveform (e.g., the Zadoff-Chu chirp) may be determined in accordance with the following Equation 10 (e.g., in accordance with a parameter q in Equation 10):

$$q = ⌊ \overline{q} + 1 / 2 ⌋ + {v ( - 1 )}^{⌊ 2 \overline{q} ⌋} , \overline{q} = {N}_{ZC} \cdot ( u + 1 ) / 31 \qquad ( 10 )$$

in which a length of N_{ZC} may correspond to a relatively largest prime number, such that N_{ZC}<M_{ZC}. In some examples, the first device may use OOK modulation to generate the length-M_{ZC} sequence by setting a value of q to 2. In some examples, the first device may use FSK modulation to generate a length-M_{ZC}/2 sequence by setting a value of q to 1. For example, the first device may place the length-M_{ZC}/2 sequence on the upper or lower half of the spectrum to convey the information bit. Additionally, the first device may use OOK and FSK modulation to generate a length-M_{ZC} sequence by setting a value of q to 1. In such examples, the first device may multiply the Zadoff-Chu sequence with one of [1, . . . ,1,0, . . . ,0]or [0, . . . ,0,1, . . . ,1], and then use the OFDM system (e.g., a DFT-S-OFDM framework) to generate the ON-OFF vs OFF-ON signal.

The first device may apply a transform 1225 to the sample sequence. In some examples, the transform 1225 may be an example of a DFT (e.g., an M-point DFT), which may transform the sample sequence from a time domain sample sequence to a frequency domain sample sequence. The first device may pass the frequency domain sample sequence into an OFDM waveform generator 1235 (e.g., a DFT-S-OFDM waveform generator). The OFDM waveform generator 1235 may generate an OFDM waveform 1240, which may be an example of a DFT-S-OFDM-based FSK signal, based on mapping the frequency domain sample sequence to a first set of one or more resource elements. In some examples, the OFDM waveform generator may apply an IFFT (e.g., using an N point IFFT, in which N>M) to the frequency domain sample sequence to generate the OFDM waveform. For example, the OFDM waveform generator may apply the IFFT to the frequency domain sample sequence to map the sample sequence in the frequency domain back into the time domain. That is, the OFDM waveform generator 1235 may be a DFT-S-OFDM waveform generate that includes an M point DFT and an N point IFFT, in which N>M. In this way, the first device may generate an OFDM-based FSK signal. Such an approach may also be used to generate an OFDM-based OOK signal.

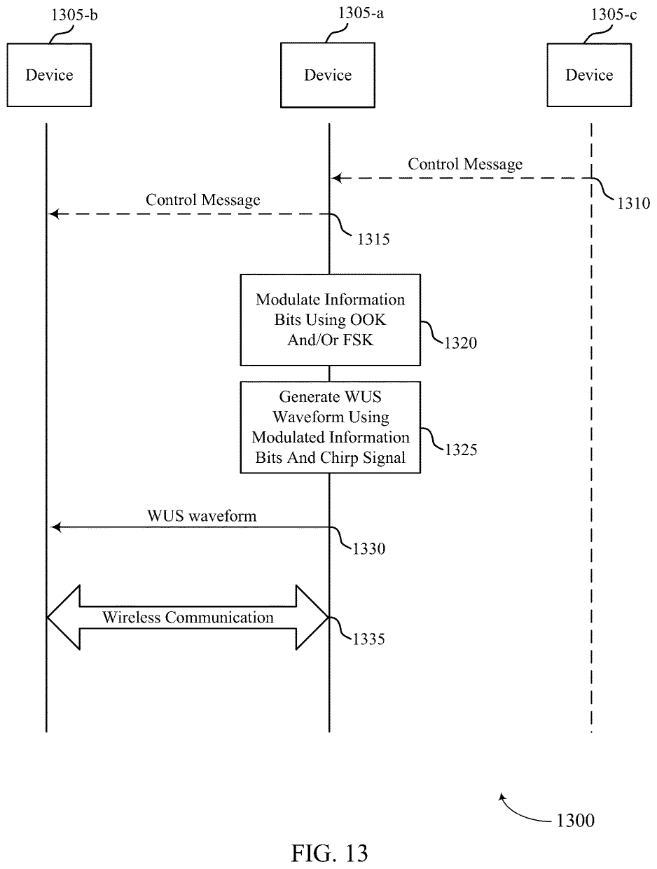

FIG. 13 shows an example of a process flow 1300 that supports modulation schemes for chirp-based WUSs in accordance with one or more aspects of the present disclosure. In some examples, the process flow 1300 may implement one or more aspects of the wireless communications system 100, the wireless communications system 200, the WUS waveform diagrams 300, the WUS waveform diagrams 400, the WUS waveform diagrams 500, the WUS waveform diagrams 600, the WUS waveform diagrams 700, the WUS waveform diagrams 800, the WUS waveform diagrams 900, the WUS waveform diagrams 1000, the WUS waveform diagrams 1100, and the waveform generation procedure 1200. For example, the process flow 1300 may include example operations associated with a device 1305-a, which may be an example of a device (e.g., a UE, a network entity) illustrated by and described with reference to FIGS. 1 through 9, 10A, 10B, 11A, 11B, and 12. The process flow 1300 may also include example operations associated with a device 1305-b, which may be an example of a device (e.g., a UE, such as an ambient IoT device) illustrated by and described with reference to FIGS. 1 through 9, 10A, 10B, 11A, 11B, and 12. In some examples, such as examples in which the device 1305-a is a UE, the process flow 1300 may include example operations associated with a device 1305-c, which may be an example of a device (e.g., a network entity) illustrated by and described with reference to FIGS. 1 through 9, 10A, 10B, 11A, 11B, and 12. The operations performed by the devices 1305 may support improvements to communications between the devices 1305, among other benefits. In the following description of the process flow 1300, the operations between the devices 1305 may occur in a different order than the example order shown. Additionally, or alternatively, the operations performed by the devices 1305 may be performed in different orders or at different times. Some operations may also be omitted and some operations may be combined.

At 1320, the device 1305-a may modulate a set of information bits using OOK, or FSK, or both. In some examples, the device 1305-a may modulate the set of information bits in accordance with a pattern. The pattern may be an example of a pattern described with reference to FIGS. 2 through 9, 10A, 10B, 11A, 11B, and 12. For example, the pattern may correspond to a respective value of one or more bits.

At 1325, the device 1305-a may generate a WUS waveform using a chirp signal and the modulated set of information bits. The WUS waveform may be an example of a WUS waveform (e.g., an LP-WUS waveform) illustrated by and described with reference to FIGS. 2 through 9, 10A, 10B, 11A, 11B, and 12. For example, the WUS waveform may correspond to an OOK-based waveform, an FSK-based waveform or an OOK/FSK-based waveform.

At 1330, the device 1305-a may transmit the WUS waveform via at least a portion of a WUS bandwidth and a portion of a WUS time duration. For example, the WUS waveform may be transmitted, such that WUS waveform occupies at least the portion of the WUS bandwidth and at least the portion of the WUS time duration in accordance with the pattern, which may be based on the modulated set of information bits. The WUS bandwidth may be an example of a WUS bandwidth illustrated by and described with reference to FIGS. 2 through 9, 10A, 10B, 11A, 11B, and 12. For example, the WUS bandwidth may be an LP-WUS bandwidth (e.g., about 4.32 MHz). Additionally, the time duration may be an example of a time duration illustrated by and described with reference to FIGS. 2 through 9, 10A, 10B, 11A, 11B, and 12. For example, the time duration may be an example of an LP-WUS symbol (e.g., an OFDM symbol). In some examples, the device 1305-a may determine the portion of the WUS bandwidth and the portion of the WUS time duration, among other parameters of a WUS scheme, based on control signaling.

For example, at 1310, the device 1305-a (e.g., a UE) may receive a control message from the device 1305-c (e.g., a network entity). The control message may indicate a WUS scheme that identifies OOK, or FSK, or both, and identifies the pattern. In such an example, modulating the set of information bits at 1320 may be based on the control message (e.g., and transmitting the WUS waveform at 1330 may be in accordance with the pattern). Additionally, or alternatively, the control message may indicate a WUS scheme that identifies the WUS bandwidth and the WUS time duration. In such an example, the device 1305-a may generate the WUS waveform at 1325 based on the control message.

In some examples, at 1315, the device 1305-a (e.g., a UE or a network entity) may transmit a control message to the device 1305-b (e.g., a UE, such as an ambient IoT device). The control message may indicate the WUS scheme that identifies OOK, or FSK, or both, and identifies the pattern. Additionally, or alternatively, the control message may indicate a WUS scheme that identifies the WUS bandwidth and the WUS time duration. In such examples, the device 1305-b may monitor for the WUS waveform at 1330 (e.g., and decode the WUS waveform) based on the control message.

In some examples, the control message received at 1310 may indicate the pattern of WUS waveform and also indicate how the WUS waveform (e.g., per chirp signal) may be generated. Accordingly, the control message transmitted at 1315 may indicate the pattern of WUS waveform and also indicate how the WUS waveform (e.g., per chirp signal) may be decoded. For example, the control message received at 1310 (o transmitted at 1315) may indicate whether a Zadoff-Chu sequence and DFT (e.g., a DFT-S-OFDM framework) is used at the device 1305-a to generate the WUS waveform. In such examples, the control message may further indicate one or more parameters used (e.g., which parameters are used) to generate the Zadoff-Chu sequence. For example, the control message may indicate a Zadoff-Chu root value, length, and cyclic shift, among other examples of parameters. In some examples, the device 1305-b may detect the WUS waveform and transition from an idle state to an active state. While operating in the active state, the device 1305-b may communicate with the device 1305-a.

For example, at 1335, the device 1305-a may communicate with the device 1305-b. In some examples, the device 1305-a may be an example of a network entity (e.g., a network node). In such an example, the communications at 1335 may include transmission of a downlink message from the device 1305-a. The downlink message may include a grant scheduling downlink or uplink communications between the device 1305-a and the device 1305-b. In some other examples, the device 1305-a may be an example of a UE. In such an example, the communications at 1335 may include transmission of a sidelink message (or an uplink message) or another type of message that may be detectable via the device 1305-b. In some examples, the device 1305-b may detect the WUS waveform with a relatively low sampling rate (e.g., with a sampling rate proportional to the data rate rather than the total bandwidth), which may lead to reduced power consumption and reduced frequency selective signal fading at the device 1305-b, among other benefits.

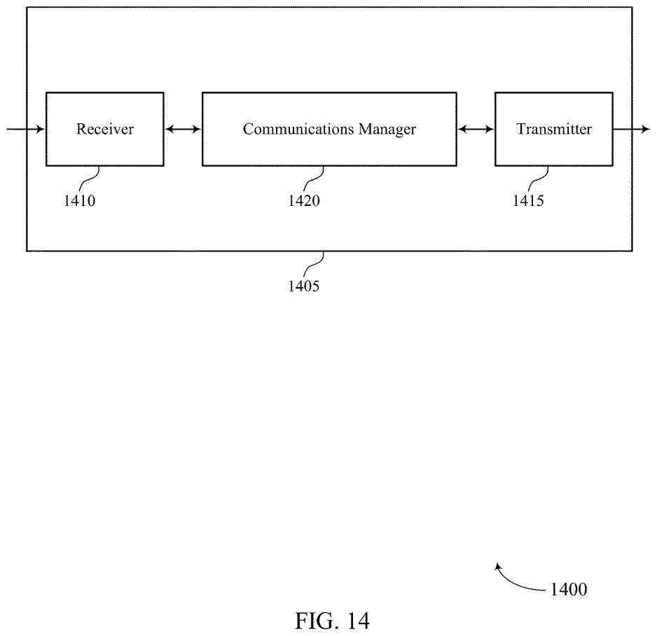

FIG. 14 shows a block diagram 1400 of a device 1405 that supports modulation schemes for chirp-based WUSs in accordance with one or more aspects of the present disclosure. The device 1405 may be an example of aspects of a UE 115 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to modulation schemes for chirp-based WUSs). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to modulation schemes for chirp-based WUSs). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of modulation schemes for chirp-based WUSs as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor. If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a device (e.g., the device 1405) in accordance with examples as disclosed herein. For example, the communications manager 1420 is capable of, configured to, or operable to support a means for modulating a set of information bits using OOK, or FSK, or both. The communications manager 1420 is capable of, configured to, or operable to support a means for generating a WUS waveform using a chirp signal and the modulated set of information bits. The communications manager 1420 is capable of, configured to, or operable to support a means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Additionally, or alternatively, the communications manager 1420 may support wireless communications at a device (e.g., the device 1405) in accordance with examples as disclosed herein. For example, the communications manager 1420 is capable of, configured to, or operable to support a means for monitoring a WUS bandwidth and a WUS time duration for a WUS waveform indicative of a set of information bits. The communications manager 1420 is capable of, configured to, or operable to support a means for receiving, based on the monitoring, the WUS waveform via at least a portion of the WUS bandwidth and a portion of the WUS time duration, where the WUS waveform is based on a chirp signal and OOK, or FSK, or both, of the set of information bits. The communications manager 1420 is capable of, configured to, or operable to support a means for transitioning from a first state to a second state based on receiving the WUS waveform.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for reduced power consumption and more efficient utilization of communication resources.

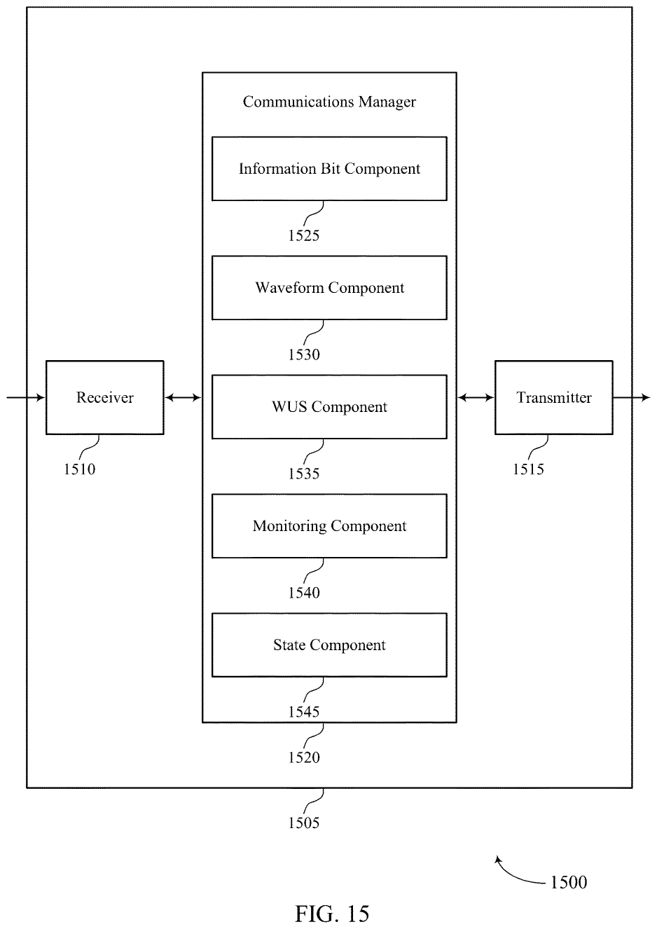

FIG. 15 shows a block diagram 1500 of a device 1505 that supports modulation schemes for chirp-based WUSs in accordance with one or more aspects of the present disclosure. The device 1505 may be an example of aspects of a device 1405, a UE 115, or a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to modulation schemes for chirp-based WUSs). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to modulation schemes for chirp-based WUSs). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of modulation schemes for chirp-based WUSs as described herein. For example, the communications manager 1520 may include an information bit component 1525, a waveform component 1530, a WUS component 1535, a monitoring component 1540, a state component 1545, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a device (e.g., the device 1505) in accordance with examples as disclosed herein. The information bit component 1525 is capable of, configured to, or operable to support a means for modulating a set of information bits using OOK, or FSK, or both. The waveform component 1530 is capable of, configured to, or operable to support a means for generating a WUS waveform using a chirp signal and the modulated set of information bits. The WUS component 1535 is capable of, configured to, or operable to support a means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Additionally, or alternatively, the communications manager 1520 may support wireless communications at a device (e.g., the device 1505) in accordance with examples as disclosed herein. The monitoring component 1540 is capable of, configured to, or operable to support a means for monitoring a WUS bandwidth and a WUS time duration for a WUS waveform indicative of a set of information bits. The WUS component 1535 is capable of, configured to, or operable to support a means for receiving, based on the monitoring, the WUS waveform via at least a portion of the WUS bandwidth and a portion of the WUS time duration, where the WUS waveform is based on a chirp signal and OOK, or FSK, or both, of the set of information bits. The state component 1545 is capable of, configured to, or operable to support a means for transitioning from a first state to a second state based on receiving the WUS waveform.

In some cases, the information bit component 1525, the waveform component 1530, the WUS component 1535, the monitoring component 1540, and the state component 1545 may each be or be at least a part of at least one processor (e.g., a transceiver processor, or a radio processor, or a transmitter processor, or a receiver processor). The at least one processor may be coupled with at least one memory and execute instructions stored in the at least one memory that enable the at least one processor to perform or facilitate the features of the information bit component 1525, the waveform component 1530, the WUS component 1535, the monitoring component 1540, and the state component 1545 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

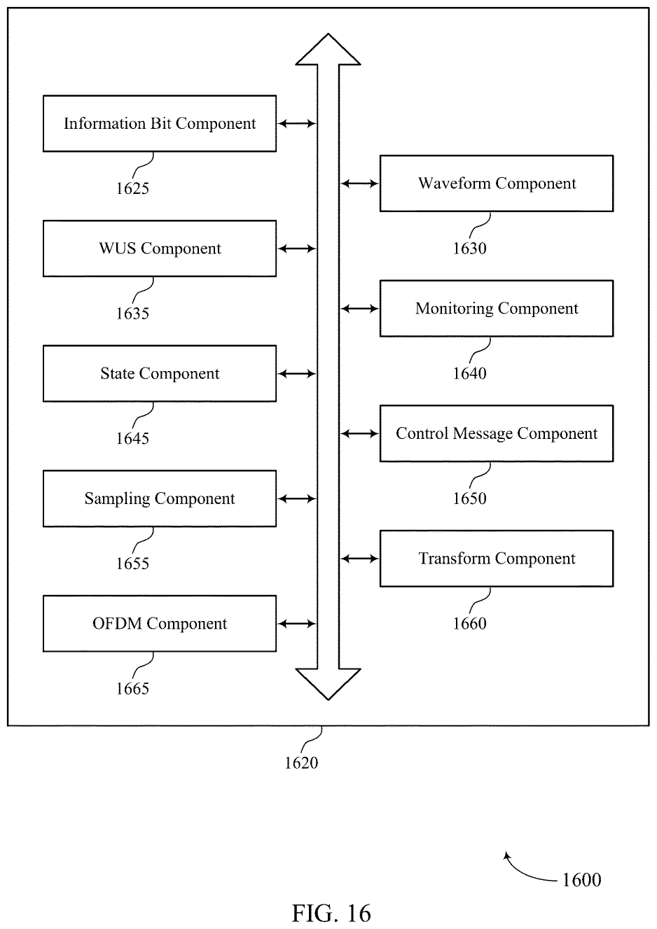

FIG. 16 shows a block diagram 1600 of a communications manager 1620 that supports modulation schemes for chirp-based WUSs in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of modulation schemes for chirp-based WUSs as described herein. For example, the communications manager 1620 may include an information bit component 1625, a waveform component 1630, a WUS component 1635, a monitoring component 1640, a state component 1645, a control message component 1650, a sampling component 1655, a transform component 1660, an OFDM component 1665, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications at a device in accordance with examples as disclosed herein. The information bit component 1625 is capable of, configured to, or operable to support a means for modulating a set of information bits using OOK, or FSK, or both. The waveform component 1630 is capable of, configured to, or operable to support a means for generating a WUS waveform using a chirp signal and the modulated set of information bits. The WUS component 1635 is capable of, configured to, or operable to support a means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

In some examples, the control message component 1650 is capable of, configured to, or operable to support a means for transmitting or receiving a control message indicating a WUS scheme that identifies OOK, or FSK, or both, and identifies the pattern, where modulating the set of information bits is based on the control message and the WUS waveform is transmitted in accordance with the pattern.

In some examples, the control message component 1650 is capable of, configured to, or operable to support a means for transmitting or receiving a control message indicating a WUS scheme that identifies one or more parameters associated with generation of the WUS waveform, wherein generating the WUS waveform is based on the control message.

In some examples, the control message component 1650 is capable of, configured to, or operable to support a means for transmitting or receiving a control message indicating a WUS scheme that identifies the WUS bandwidth and the WUS time duration, and where generating the WUS waveform is based on the control message.

In some examples, the WUS waveform occupies the WUS bandwidth and the portion of the WUS time duration. In some examples, the portion of the WUS time duration occupied by the WUS waveform indicates a bit value for a first bit of the set of information bits in accordance with the pattern. In some examples, the WUS waveform occupies the portion of the WUS bandwidth and the WUS time duration. In some examples, the portion of the WUS bandwidth occupied by the WUS waveform indicates a bit value for a first bit of the set of information bits in accordance with the pattern.

In some examples, the WUS waveform occupies the portion of the WUS bandwidth and the portion of the WUS time duration. In some examples, the portion of the WUS bandwidth and the portion of the WUS time duration indicate at least a first bit value for a first bit of the set of information bits in accordance with the pattern. In some examples, the portion of the WUS bandwidth and the portion of the WUS time duration occupied by the WUS waveform indicate the first bit value for the first bit and a second bit value for a second bit of the set of information bits in accordance with the pattern.

In some examples, a first portion of the WUS waveform occupies the portion of the WUS bandwidth and the portion of the WUS time duration to indicate a first value for a first bit of the set of information bits in accordance with the pattern, and a second portion of the WUS waveform occupies a second portion of the WUS bandwidth and a second portion of the WUS time duration to indicate a second value for a second bit of the set of information bits in accordance with the pattern.

In some examples, the chirp signal includes a monotone frequency signal with a slope that increases or decreases linearly over time. In some examples, at least the pattern, or the slope, or both, indicate a first value for a first bit of the set of information bits. In some examples, the slope indicates the first value for the first bit of the set of information bits and the pattern indicates a second value for a second bit of the set of information bits.

In some examples, the first value for the first bit is based on a frequency offset associated with the chirp signal, a value of the slope, or whether the slope increases or decreases linearly over time, or any combination thereof. In some examples, the chirp signal includes a non-linear chirp signal.

In some examples, the sampling component 1655 is capable of, configured to, or operable to support a means for obtaining a time domain sample sequence based on sampling the WUS waveform within at least the portion of the WUS bandwidth and the portion of the WUS time duration. In some examples, the transform component 1660 is capable of, configured to, or operable to support a means for applying a transform to the time domain sample sequence to generate a frequency domain sample sequence. In some examples, the OFDM component 1665 is capable of, configured to, or operable to support a means for generating an OFDM waveform based on mapping the frequency domain sample sequence to a set of multiple resource elements, where the WUS waveform is the OFDM waveform. In some examples, the chirp signal includes a Zadoff-Chu sequence. In some examples, the WUS waveform is an LP-WUS waveform.

Additionally, or alternatively, the communications manager 1620 may support wireless communications at a device in accordance with examples as disclosed herein. The monitoring component 1640 is capable of, configured to, or operable to support a means for monitoring a WUS bandwidth and a WUS time duration for a WUS waveform indicative of a set of information bits. In some examples, the WUS component 1635 is capable of, configured to, or operable to support a means for receiving, based on the monitoring, the WUS waveform via at least a portion of the WUS bandwidth and a portion of the WUS time duration, where the WUS waveform is based on a chirp signal and OOK, or FSK, or both, of the set of information bits. The state component 1645 is capable of, configured to, or operable to support a means for transitioning from a first state to a second state based on receiving the WUS waveform.

In some examples, the control message component 1650 is capable of, configured to, or operable to support a means for transmitting or receiving a control message indicating a WUS scheme that identifies OOK, or FSK, or both, where receiving the WUS waveform is based on the control message.

In some examples, the control message component 1650 is capable of, configured to, or operable to support a means for transmitting or receiving a control message indicating a WUS scheme that identifies the WUS bandwidth and the WUS time duration, and where monitoring the WUS bandwidth and the WUS time duration is based on the control message.

In some examples, the waveform component 1630 is capable of, configured to, or operable to support a means for decoding the WUS waveform to obtain the set of information bits. In some examples, the waveform component 1630 is capable of, configured to, or operable to support a means for performing a de-chirp operation, or a filtering operation, or both, where decoding the WUS waveform is based on the de-chirp operation, or the filtering operation, or both.

In some examples, the waveform component 1630 is capable of, configured to, or operable to support a means for identifying a correlation between the WUS waveform and a first type of chirp signal or a second type of chirp signal, where decoding the WUS waveform is based on the correlation.

In some examples, the WUS waveform occupies the WUS bandwidth and the portion of the WUS time duration. In some examples, the portion of the WUS time duration occupied by the WUS waveform indicates a bit value for a first bit of the set of information bits in accordance with a pattern.

In some examples, the WUS waveform occupies the portion of the WUS bandwidth and the WUS time duration. In some examples, the portion of the WUS bandwidth occupied by the WUS waveform indicates a bit value for a first bit of the set of information bits in accordance with a pattern.

In some examples, the WUS waveform occupies the portion of the WUS bandwidth and the portion of the WUS time duration. In some examples, the portion of the WUS bandwidth and the portion of the WUS time duration indicate at least a first bit value for a first bit of the set of information bits in accordance with a pattern.

In some examples, the portion of the WUS bandwidth and the portion of the WUS time duration occupied by the WUS waveform indicates the first bit value for the first bit and a second bit value for a second bit of the set of information bits in accordance with the pattern.

In some examples, a first portion of the WUS waveform occupies the portion of the WUS bandwidth and the portion of the WUS time duration to indicate a first value for a first bit of the set of information bits in accordance with a pattern, and a second portion of the WUS waveform occupies a second portion of the WUS bandwidth and a second portion of the WUS time duration to indicate a second value for a second bit of the set of information bits in accordance with the pattern.

In some examples, the chirp signal includes a monotone frequency signal with a slope that increases or decreases linearly. In some examples, at least a pattern associated with the WUS waveform, or the slope, or both, indicate a first value for a first bit of the set of information bits.

In some examples, the slope indicates the first value for the first bit of the set of information bits and the pattern indicates a second value for a second bit of the set of information bits. In some examples, the first value for the first bit is based on a frequency offset associated with the chirp signal, a value of the slope, or whether the slope increases or decreases linearly over time, or any combination thereof.

In some examples, the chirp signal includes a non-linear chirp signal. In some examples, the WUS waveform is an OFDM waveform. In some examples, the chirp signal includes a Zadoff-Chu sequence. In some examples, the WUS waveform is an LP-WUS waveform.

In some cases, the information bit component 1625, the waveform component 1630, the WUS component 1635, the monitoring component 1640, the state component 1645, the control message component 1650, the sampling component 1655, the transform component 1660, and the OFDM component 1665 may each be or be at least a part of at least one processor (e.g., a transceiver processor, or a radio processor, or a transmitter processor, or a receiver processor). The at least one processor may be coupled with at least one memory and execute instructions stored in the at least one memory that enable the at least one processor to perform or facilitate the features of the information bit component 1625, the waveform component 1630, the WUS component 1635, the monitoring component 1640, the state component 1645, the control message component 1650, the sampling component 1655, the transform component 1660, and the OFDM component 1665 discussed herein.

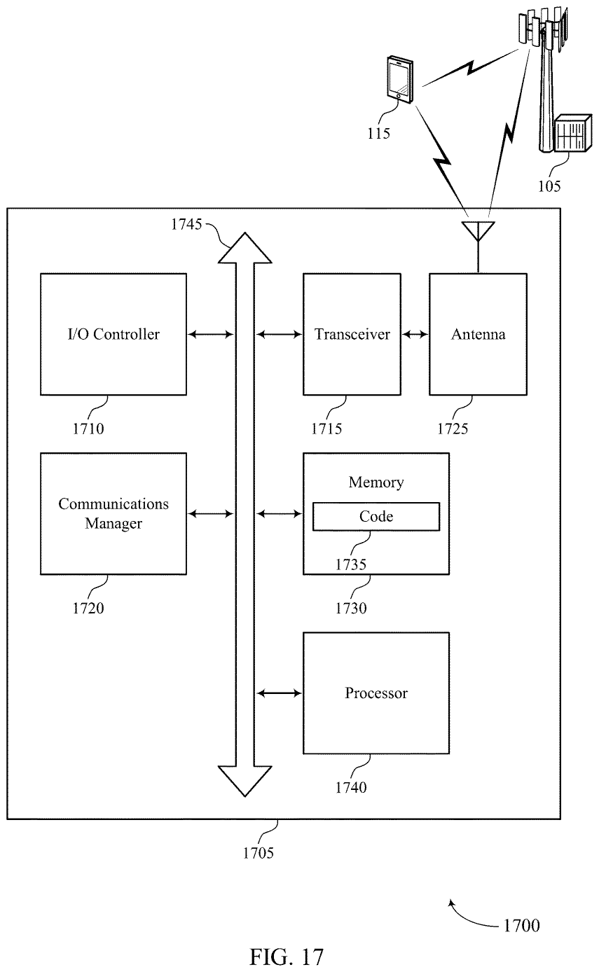

FIG. 17 shows a diagram of a system 1700 including a device 1705 that supports modulation schemes for chirp-based WUSs in accordance with one or more aspects of the present disclosure. The device 1705 may be an example of or include the components of a device 1405, a device 1505, or a UE 115 as described herein. The device 1705 may communicate (e.g., wirelessly) with one or more network entities 105, one or more UEs 115, or any combination thereof. The device 1705 may include components for bi-directional voice and data communications including components for transmitting and receiving communications, such as a communications manager 1720, an input/output (I/O) controller 1710, a transceiver 1715, an antenna 1725, at least one memory 1730, code 1735, and at least one processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®, or another known operating system. Additionally, or alternatively, the I/O controller 1710 may represent or interact with a modem, a keyboard, a mouse, a touchscreen, or a similar device. In some cases, the I/O controller 1710 may be implemented as part of one or more processors, such as the at least one processor 1740. In some cases, a user may interact with the device 1705 via the I/O controller 1710 or via hardware components controlled by the I/O controller 1710.

In some cases, the device 1705 may include a single antenna 1725. However, in some other cases, the device 1705 may have more than one antenna 1725, which may be capable of concurrently transmitting or receiving multiple wireless transmissions. The transceiver 1715 may communicate bi-directionally, via the one or more antennas 1725, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The at least one memory 1730 may include random access memory (RAM) and read-only memory (ROM). The at least one memory 1730 may store computer-readable, computer-executable code 1735 including instructions that, when executed by the at least one processor 1740, cause the device 1705 to perform various functions described herein. The code 1735 may be stored in a non-transitory computer-readable medium such as system memory or another type of memory. In some cases, the code 1735 may not be directly executable by the at least one processor 1740 but may cause a computer (e.g., when compiled and executed) to perform functions described herein. In some cases, the at least one memory 1730 may contain, among other things, a basic I/O system (BIOS) which may control basic hardware or software operation such as the interaction with peripheral components or devices.

The at least one processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1740 may be configured to operate a memory array using a memory controller. In some other cases, a memory controller may be integrated into the at least one processor 1740. The at least one processor 1740 may be configured to execute computer-readable instructions stored in a memory (e.g., the at least one memory 1730) to cause the device 1705 to perform various functions (e.g., functions or tasks supporting modulation schemes for chirp-based WUSs). For example, the device 1705 or a component of the device 1705 may include at least one processor 1740 and at least one memory 1730 coupled with or to the at least one processor 1740, the at least one processor 1740 and at least one memory 1730 configured to perform various functions described herein. In some examples, the at least one processor 1740 may include multiple processors and the at least one memory 1730 may include multiple memories. One or more of the multiple processors may be coupled with one or more of the multiple memories, which may, individually or collectively, be configured to perform various functions herein.

The communications manager 1720 may support wireless communications at a device (e.g., the device 1705) in accordance with examples as disclosed herein. For example, the communications manager 1720 is capable of, configured to, or operable to support a means for modulating a set of information bits using OOK, or FSK, or both. The communications manager 1720 is capable of, configured to, or operable to support a means for generating a WUS waveform using a chirp signal and the modulated set of information bits. The communications manager 1720 is capable of, configured to, or operable to support a means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Additionally, or alternatively, the communications manager 1720 may support wireless communications at a device (e.g., the device 1705) in accordance with examples as disclosed herein. For example, the communications manager 1720 is capable of, configured to, or operable to support a means for monitoring a WUS bandwidth and a WUS time duration for a WUS waveform indicative of a set of information bits. The communications manager 1720 is capable of, configured to, or operable to support a means for receiving, based on the monitoring, the WUS waveform via at least a portion of the WUS bandwidth and a portion of the WUS time duration, where the WUS waveform is based on a chirp signal and OOK, or FSK, or both, of the set of information bits. The communications manager 1720 is capable of, configured to, or operable to support a means for transitioning from a first state to a second state based on receiving the WUS waveform.

By including or configuring the communications manager 1720 in accordance with examples as described herein, the device 1705 may support techniques for improved communication reliability, reduced latency, reduced power consumption, more efficient utilization of communication resources, and longer battery life.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the at least one processor 1740, the at least one memory 1730, the code 1735, or any combination thereof. For example, the code 1735 may include instructions executable by the at least one processor 1740 to cause the device 1705 to perform various aspects of modulation schemes for chirp-based WUSs as described herein, or the at least one processor 1740 and the at least one memory 1730 may be otherwise configured to, individually or collectively, perform or support such operations.

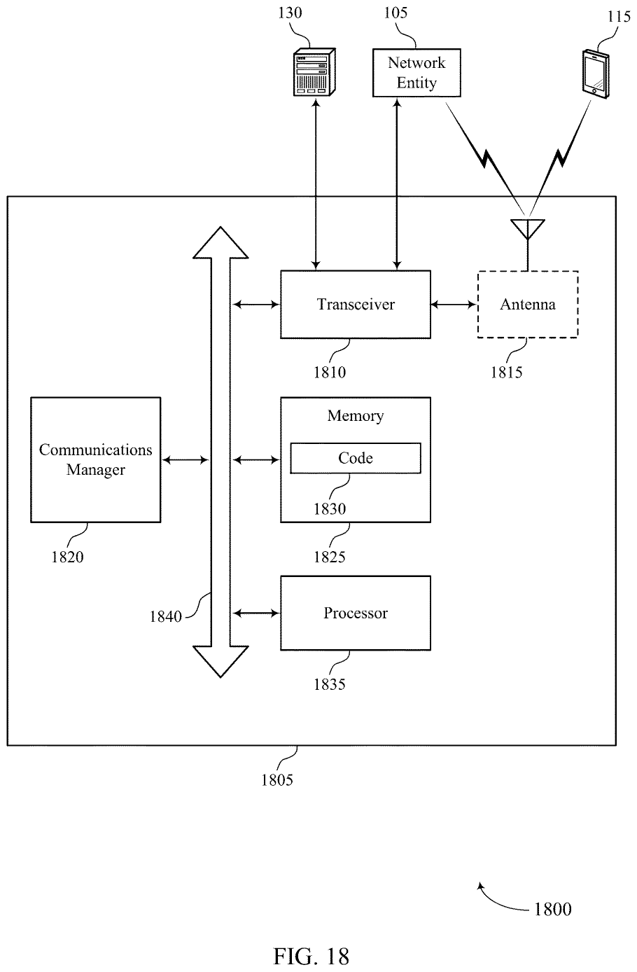

FIG. 18 shows a diagram of a system 1800 including a device 1805 that supports modulation schemes for chirp-based WUSs in accordance with one or more aspects of the present disclosure. The device 1805 may be an example of or include the components of a device 1405, a device 1505, or a network entity 105 as described herein. The device 1805 may communicate with one or more network entities 105, one or more UEs 115, or any combination thereof, which may include communications over one or more wired interfaces, over one or more wireless interfaces, or any combination thereof. The device 1805 may include components that support outputting and obtaining communications, such as a communications manager 1820, a transceiver 1810, an antenna 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or memory components (for example, the at least one processor 1835, or the at least one memory 1825, or both), may be included in a chip or chip assembly that is installed in the device 1805. In some examples, the transceiver may be operable to support communications via one or more communications links (e.g., a communication link 125, a backhaul communication link 120, a midhaul communication link 162, a fronthaul communication link 168).

The at least one memory 1825 may include RAM and ROM. The at least one memory 1825 may store computer-readable, computer-executable code 1830 including instructions that, when executed by the at least one processor 1835, cause the device 1805 to perform various functions described herein. The code 1830 may be stored in a non-transitory computer-readable medium such as system memory or another type of memory. In some cases, the code 1830 may not be directly executable by the at least one processor 1835 but may cause a computer (e.g., when compiled and executed) to perform functions described herein. In some cases, the at least one memory 1825 may contain, among other things, a BIOS which may control basic hardware or software operation such as the interaction with peripheral components or devices.

The at least one processor 1835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1835 may be configured to operate a memory array using a memory controller. In some other cases, a memory controller may be integrated into the at least one processor 1835. The at least one processor 1835 may be configured to execute computer-readable instructions stored in a memory (e.g., the at least one memory 1825) to cause the device 1805 to perform various functions (e.g., functions or tasks supporting modulation schemes for chirp-based WUSs). For example, the device 1805 or a component of the device 1805 may include at least one processor 1835 and at least one memory 1825 coupled with the at least one processor 1835, the at least one processor 1835 and at least one memory 1825 configured to perform various functions described herein. In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within the at least one memory 1825). In some implementations, the at least one processor 1835 may be a component of a processing system. A processing system may generally refer to a system or series of machines or components that receives inputs and processes the inputs to produce a set of outputs (which may be passed to other systems or components of, for example, the device 1805). For example, a processing system of the device 1805 may refer to a system including the various other components or subcomponents of the device 1805, such as the at least one processor 1835, or the transceiver 1810, or the communications manager 1820, or other components or combinations of components of the device 1805. The processing system of the device 1805 may interface with other components of the device 1805, and may process information received from other components (such as inputs or signals) or output information to other components. For example, a chip or modem of the device 1805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1805 may transmit information output from the chip or modem. Additionally, or alternatively, in some implementations, the one or more interfaces may refer to an interface between the processing system of the chip or modem and a receiver, such that the device 1805 may obtain information or signal inputs, and the information may be passed to the processing system. A person having ordinary skill in the art will readily recognize that a first interface also may obtain information or signal inputs, and a second interface also may output information or signal outputs.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with other network entities 105, and may include a controller or scheduler for controlling communications with UEs 115 in cooperation with other network entities 105. In some examples, the communications manager 1820 may support an X2 interface within an LTE/LTE-A wireless communications network technology to provide communication between network entities 105.

The communications manager 1820 may support wireless communications at a device (e.g., the device 1805) in accordance with examples as disclosed herein. For example, the communications manager 1820 is capable of, configured to, or operable to support a means for modulating a set of information bits using OOK, or FSK, or both. The communications manager 1820 is capable of, configured to, or operable to support a means for generating a WUS waveform using a chirp signal and the modulated set of information bits. The communications manager 1820 is capable of, configured to, or operable to support a means for transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits.

Additionally, or alternatively, the communications manager 1820 may support wireless communications at a device (e.g., the device 1805) in accordance with examples as disclosed herein. For example, the communications manager 1820 is capable of, configured to, or operable to support a means for monitoring a WUS bandwidth and a WUS time duration for a WUS waveform indicative of a set of information bits. The communications manager 1820 is capable of, configured to, or operable to support a means for receiving, based on the monitoring, the WUS waveform via at least a portion of the WUS bandwidth and a portion of the WUS time duration, where the WUS waveform is based on a chirp signal and OOK, or FSK, or both, of the set of information bits. The communications manager 1820 is capable of, configured to, or operable to support a means for transitioning from a first state to a second state based on receiving the WUS waveform.

By including or configuring the communications manager 1820 in accordance with examples as described herein, the device 1805 may support techniques for improved communication reliability, reduced latency, reduced power consumption, more efficient utilization of communication resources, and longer battery life.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, the at least one processor 1835, the at least one memory 1825, the code 1830, or any combination thereof. For example, the code 1830 may include instructions executable by the at least one processor 1835 to cause the device 1805 to perform various aspects of modulation schemes for chirp-based WUSs as described herein, or the at least one processor 1835 and the at least one memory 1825 may be otherwise configured to perform or support such operations.

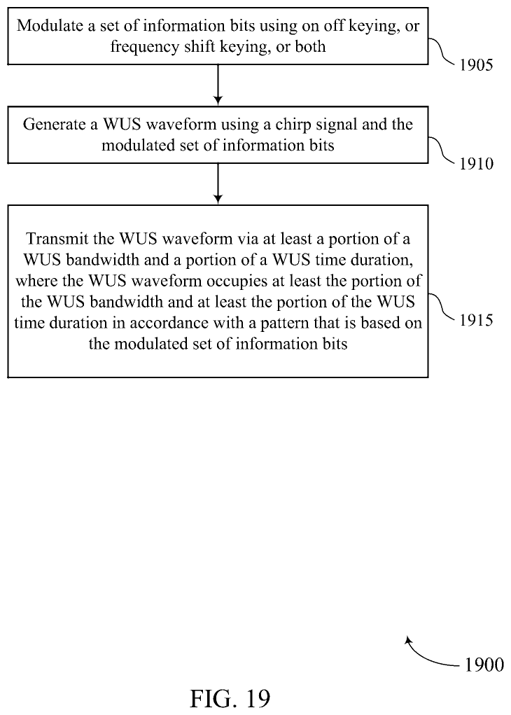

FIG. 19 shows a flowchart illustrating a method 1900 that supports modulation schemes for chirp-based WUSs in accordance with aspects of the present disclosure. The operations of the method 1900 may be implemented by a UE or a network entity or its components as described herein. For example, the operations of the method 1900 may be performed by a UE 115 or a network entity as described with reference to FIGS. 1 through 18. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include modulating a set of information bits using OOK, or FSK, or both. The operations of block 1905 may be performed in accordance with examples as disclosed herein. In some examples, aspects of the operations of 1905 may be performed by an information bit component 1625 as described with reference to FIG. 16.

At 1910, the method may include generating a WUS waveform using a chirp signal and the modulated set of information bits. The operations of block 1910 may be performed in accordance with examples as disclosed herein. In some examples, aspects of the operations of 1910 may be performed by a waveform component 1630 as described with reference to FIG. 16.

At 1915, the method may include transmitting the WUS waveform via at least a portion of a WUS bandwidth and a portion of a WUS time duration, where the WUS waveform occupies at least the portion of the WUS bandwidth and at least the portion of the WUS time duration in accordance with a pattern that is based on the modulated set of information bits. The operations of block 1915 may be performed in accordance with examples as disclosed herein. In some examples, aspects of the operations of 1915 may be performed by a WUS component 1635 as described with reference to FIG. 16.

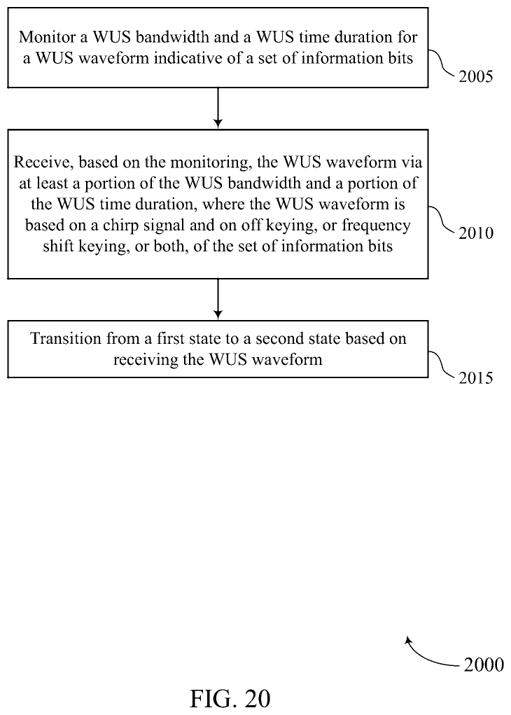

FIG. 20 shows a flowchart illustrating a method 2000 that supports modulation schemes for chirp-based WUSs in accordance with aspects of the present disclosure. The operations of the method 2000 may be implemented by a UE or a network entity or its components as described herein. For example, the operations of the method 2000 may be performed by a UE 115 or a network entity as described with reference to FIGS. 1 through 18. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include monitoring a WUS bandwidth and a WUS time duration for a WUS waveform indicative of a set of information bits. The operations of block 2005 may be performed in accordance with examples as disclosed herein. In some examples, aspects of the operations of 2005 may be performed by a monitoring component 1640 as described with reference to FIG. 16.

At 2010, the method may include receiving, based on the monitoring, the WUS waveform via at least a portion of the WUS bandwidth and a portion of the WUS time duration, where the WUS waveform is based on a chirp signal and OOK, or FSK, or both, of the set of information bits. The operations of block 2010 may be performed in accordance with examples as disclosed herein. In some examples, aspects of the operations of 2010 may be performed by a WUS component 1635 as described with reference to FIG. 16.

At 2015, the method may include transitioning from a first state to a second state based on receiving the WUS waveform. The operations of block 2015 may be performed in accordance with examples as disclosed herein. In some examples, aspects of the operations of 2015 may be performed by a state component 1645 as described with reference to FIG. 16.

The following provides an overview of aspects of the present disclosure:

Aspect 1: A method for wireless communications at a device, comprising: modulating a set of information bits using OOK, or FSK, or both; generating a WUS waveform using a chirp signal and the modulated set of information bits; and transmitting the WUS waveform via at least a portion of a WUS bandwidth and a portion of a WUS time duration, wherein the WUS waveform occupies at least the portion of the WUS bandwidth and at least the portion of the WUS time duration in accordance with a pattern that is based at least in part on the modulated set of information bits.

Aspect 2: The method of aspect 1, further comprising: transmitting or receiving a control message indicating a WUS scheme that identifies OOK, or FSK, or both, and identifies the pattern, wherein modulating the set of information bits is based at least in part on the control message and the WUS waveform is transmitted in accordance with the pattern.

Aspect 3: The method of any of aspects 1 through 2, further comprising: transmitting or receiving a control message indicating a WUS scheme that identifies one or more parameters associated with generation of the WUS waveform, wherein generating the WUS waveform is based at least in part on the control message.

Aspect 4: The method of any of aspects 1 through 3, further comprising: transmitting or receiving a control message indicating a WUS scheme that identifies the WUS bandwidth and the WUS time duration, wherein generating the WUS waveform is based at least in part on the control message.

Aspect 5: The method of any of aspects 1 through 4, wherein the WUS waveform occupies the WUS bandwidth and the portion of the WUS time duration, and the portion of the WUS time duration occupied by the WUS waveform indicates a bit value for a first bit of the set of information bits in accordance with the pattern.

Aspect 6: The method of any of aspects 1 through 4, wherein the WUS waveform occupies the portion of the WUS bandwidth and the WUS time duration, and the portion of the WUS bandwidth occupied by the WUS waveform indicates a bit value for a first bit of the set of information bits in accordance with the pattern.

Aspect 7: The method of any of aspects 1 through 4, wherein the WUS waveform occupies the portion of the WUS bandwidth and the portion of the WUS time duration, and the portion of the WUS bandwidth and the portion of the WUS time duration indicate at least a first bit value for a first bit of the set of information bits in accordance with the pattern.

Aspect 8: The method of aspect 7, wherein the portion of the WUS bandwidth and the portion of the WUS time duration occupied by the WUS waveform indicate the first bit value for the first bit and a second bit value for a second bit of the set of information bits in accordance with the pattern.

Aspect 9: The method of any of aspects 1 through 4, wherein a first portion of the WUS waveform occupies the portion of the WUS bandwidth and the portion of the WUS time duration to indicate a first value for a first bit of the set of information bits in accordance with the pattern, and a second portion of the WUS waveform occupies a second portion of the WUS bandwidth and a second portion of the WUS time duration to indicate a second value for a second bit of the set of information bits in accordance with the pattern.

Aspect 10: The method of any of aspects 1 through 9, wherein the chirp signal comprises a monotone frequency signal with a slope that increases or decreases linearly over time.

Aspect 11: The method of aspect 10, wherein at least the pattern, or the slope, or both, indicate a first value for a first bit of the set of information bits.

Aspect 12: The method of aspect 11, wherein the slope indicates the first value for the first bit of the set of information bits and the pattern indicates a second value for a second bit of the set of information bits.

Aspect 13: The method of aspect 11, wherein the first value for the first bit is based at least in part on a frequency offset associated with the chirp signal, a value of the slope, or whether the slope increases or decreases linearly over time, or any combination thereof.

Aspect 14: The method of any of aspects 1 through 9, wherein the chirp signal comprises a non-linear chirp signal.

Aspect 15: The method of any of aspects 1 through 14, further comprising: obtaining a time domain sample sequence based at least in part on sampling the WUS waveform within at least the portion of the WUS bandwidth and the portion of the WUS time duration; applying a transform to the time domain sample sequence to generate a frequency domain sample sequence; and generating an OFDM waveform based at least in part on mapping the frequency domain sample sequence to a plurality of resource elements, wherein the WUS waveform is the OFDM waveform.

Aspect 16: The method of aspect 15, wherein the chirp signal comprises a Zadoff Chu sequence.

Aspect 17: The method of any of aspects 1 through 16, wherein the WUS waveform is an LP-WUS waveform.

Aspect 18: A method for wireless communications at a device, comprising: monitoring a WUS bandwidth and a WUS time duration for a WUS waveform indicative of a set of information bits; receiving, based at least in part on the monitoring, the WUS waveform via at least a portion of the WUS bandwidth and a portion of the WUS time duration, wherein the WUS waveform is based at least in part on a chirp signal and OOK, or FSK, or both, of the set of information bits; and transitioning from a first state to a second state based at least in part on receiving the WUS waveform.

Aspect 19: The method of aspect 18, further comprising: transmitting or receiving a control message indicating a WUS scheme that identifies OOK, or FSK, or both, wherein receiving the WUS waveform is based at least in part on the control message.

Aspect 20: The method of any of aspects 18 through 19, further comprising: transmitting or receiving a control message indicating a WUS scheme that identifies one or more parameters associated with generation of the WUS waveform, wherein receiving the WUS waveform is based at least in part on the control message.

Aspect 21: The method of any of aspects 18 through 20, further comprising: transmitting or receiving a control message indicating a WUS scheme that identifies the WUS bandwidth and the WUS time duration, wherein monitoring the WUS bandwidth and the WUS time duration is based at least in part on the control message.

Aspect 22: The method of any of aspects 18 through 21, further comprising: decoding the WUS waveform to obtain the set of information bits.

Aspect 23: The method of aspect 22, further comprising: performing a de-chirp operation, or a filtering operation, or both, wherein decoding the WUS waveform is based at least in part on the de-chirp operation, or the filtering operation, or both.

Aspect 24: The method of aspect 22, further comprising: identifying a correlation between the WUS waveform and a first type of chirp signal or a second type of chirp signal, wherein decoding the WUS waveform is based at least in part on the correlation.

Aspect 25: The method of any of aspects 18 through 24, wherein the WUS waveform occupies the WUS bandwidth and the portion of the WUS time duration, and the portion of the WUS time duration occupied by the WUS waveform indicates a bit value for a first bit of the set of information bits in accordance with a pattern.

Aspect 26: The method of any of aspects 18 through 24, wherein the WUS waveform occupies the portion of the WUS bandwidth and the WUS time duration, and the portion of the WUS bandwidth occupied by the WUS waveform indicates a bit value for a first bit of the set of information bits in accordance with a pattern.

Aspect 27: The method of any of aspects 18 through 24, wherein the WUS waveform occupies the portion of the WUS bandwidth and the portion of the WUS time duration, and the portion of the WUS bandwidth and the portion of the WUS time duration indicate at least a first bit value for a first bit of the set of information bits in accordance with a pattern.

Aspect 28: The method of aspect 27, wherein the portion of the WUS bandwidth and the portion of the WUS time duration occupied by the WUS waveform indicates the first bit value for the first bit and a second bit value for a second bit of the set of information bits in accordance with the pattern.

Aspect 29: The method of any of aspects 18 through 24, wherein a first portion of the WUS waveform occupies the portion of the WUS bandwidth and the portion of the WUS time duration to indicate a first value for a first bit of the set of information bits in accordance with a pattern, and a second portion of the WUS waveform occupies a second portion of the WUS bandwidth and a second portion of the WUS time duration to indicate a second value for a second bit of the set of information bits in accordance with the pattern.

Aspect 30: The method of any of aspects 18 through 29, wherein the chirp signal comprises a monotone frequency signal with a slope that increases or decreases linearly.

Aspect 31: The method of aspect 30, wherein at least a pattern associated with the WUS waveform, or the slope, or both, indicate a first value for a first bit of the set of information bits.

Aspect 32: The method of aspect 31, wherein the slope indicates the first value for the first bit of the set of information bits and the pattern indicates a second value for a second bit of the set of information bits.

Aspect 33: The method of aspect 31, wherein the first value for the first bit is based at least in part on a frequency offset associated with the chirp signal, a value of the slope, or whether the slope increases or decreases linearly over time, or any combination thereof.

Aspect 34: The method of any of aspects 18 through 29, wherein the chirp signal comprises a non-linear chirp signal.

Aspect 35: The method of any of aspects 18 through 34, wherein the WUS waveform is an OFDM waveform.

Aspect 36: The method of aspect 35, wherein the chirp signal comprises a Zadoff Chu sequence.

Aspect 37: The method of any of aspects 18 through 36, wherein the WUS waveform is an LP-WUS waveform.

Aspect 38: An apparatus for wireless communications at a device, comprising at least one memory; and at least one processor coupled to the at least one memory, the at least one processor configured to perform a method of any of aspects 1 through 17.

Aspect 39: An apparatus for wireless communications at a device, comprising at least one means for performing a method of any of aspects 1 through 17.

Aspect 40: A non-transitory computer-readable medium storing code for wireless communications at a device, the code comprising instructions executable by at least one processor to perform a method of any of aspects 1 through 17.

Aspect 41: An apparatus for wireless communications at a device, comprising at least one memory; and at least one processor coupled to the at least one memory, the at least one processor configured to perform a method of any of aspects 18 through 37.

Aspect 42: An apparatus for wireless communications at a device, comprising at least one means for performing a method of any of aspects 18 through 37.

Aspect 43: A non-transitory computer-readable medium storing code for wireless communications at a device, the code comprising instructions executable by at least one processor to perform a method of any of aspects 18 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented using hardware, software executed by at least one processor, firmware, or any combination thereof. If implemented using software executed by at least one processor, the functions may be stored as or transmitted using one or more instructions or code of a computer-readable medium. Other examples and implementations are within the scope of the disclosure and appended claims. For example, due to the nature of software, functions described herein may be implemented using software executed by at least one processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

Any functions or operations described herein as being capable of being performed by a memory may be performed by multiple memories that, individually or collectively, are capable of performing the described functions or operations. For example, the functions described herein may be performed by multiple memories, each tasked with at least a subset of the described functions, such that, collectively, the multiple memories perform all of the described functions. As such, the described functions can be performed by a single memory or a group of memories functioning together (i.e., collectively) to perform the described functions, where any one memory performs at least a subset of the described functions.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a device, comprising:
at least one memory; and
at least one processor coupled to the at least one memory, the at least one processor configured to:
modulate a set of information bits using on-off keying, or frequency shift keying, or both; generate a wakeup signal waveform using a chirp signal and the modulated set of information bits; and
transmit the wakeup signal waveform via at least a portion of a wakeup signal bandwidth and a portion of a wakeup signal time duration, wherein the wakeup signal waveform occupies at least the portion of the wakeup signal bandwidth and at least the portion of the wakeup signal time duration in accordance with a pattern that is based at least in part on the modulated set of information bits.

2. The apparatus of claim 1, wherein the at least one processor is configured to:
transmit or receive a control message indicating a wakeup signal scheme that identifies on-off keying, or frequency shift keying, or both, and identifies the pattern, wherein modulating the set of information bits is based at least in part on the control message and the wakeup signal waveform is transmitted in accordance with the pattern.

3. The apparatus of claim 1, wherein the at least one processor is configured to:
transmit or receive a control message indicating a wakeup signal scheme that identifies one or more parameters associated with generation of the wakeup signal waveform, wherein generating the wakeup signal waveform is based at least in part on the control message.

4. The apparatus of claim 1, wherein the at least one processor is configured to:
transmit or receive a control message indicating a wakeup signal scheme that identifies the wakeup signal bandwidth and the wakeup signal time duration, wherein generating the wakeup signal waveform is based at least in part on the control message.

5. The apparatus of claim 1, wherein:
the wakeup signal waveform occupies the wakeup signal bandwidth and the portion of the wakeup signal time duration, and
the portion of the wakeup signal time duration occupied by the wakeup signal waveform indicates a bit value for a first bit of the set of information bits in accordance with the pattern.

6. The apparatus of claim 1, wherein:
the wakeup signal waveform occupies the portion of the wakeup signal bandwidth and the wakeup signal time duration, and
the portion of the wakeup signal bandwidth occupied by the wakeup signal waveform indicates a bit value for a first bit of the set of information bits in accordance with the pattern.

7. The apparatus of claim 1, wherein:
the wakeup signal waveform occupies the portion of the wakeup signal bandwidth and the portion of the wakeup signal time duration,
the portion of the wakeup signal bandwidth and the portion of the wakeup signal time duration indicate at least a first bit value for a first bit of the set of information bits in accordance with the pattern, and
the portion of the wakeup signal bandwidth and the portion of the wakeup signal time duration occupied by the wakeup signal waveform indicate a second bit value for a second bit of the set of information bits in accordance with the pattern.

8. (canceled)

9. The apparatus of claim 1, wherein a first portion of the wakeup signal waveform occupies the portion of the wakeup signal bandwidth and the portion of the wakeup signal time duration to indicate a first value for a first bit of the set of information bits in accordance with the pattern, and a second portion of the wakeup signal waveform occupies a second portion of the wakeup signal bandwidth and a second portion of the wakeup signal time duration to indicate a second value for a second bit of the set of information bits in accordance with the pattern.

10. (canceled)

11. The apparatus of claim 1, wherein the chirp signal comprises a monotone frequency signal with a slope that increases or decreases linearly over time, and wherein at least the pattern, or the slope, or both, indicate a first value for a first bit of the set of information bits.

12. The apparatus of claim 11, wherein the slope indicates the first value for the first bit of the set of information bits and the pattern indicates a second value for a second bit of the set of information bits.

13. The apparatus of claim 11, wherein the first value for the first bit is based at least in part on a frequency offset associated with the chirp signal, a value of the slope, or whether the slope increases or decreases linearly over time, or any combination thereof.

14-17. (canceled)

18. An apparatus for wireless communications at a device, comprising:
at least one memory; and
at least one processor coupled to the at least one memory, the at least one processor configured to:
monitor a wakeup signal bandwidth and a wakeup signal time duration for a wakeup signal waveform indicative of a set of information bits;
receive, based at least in part on the monitoring, the wakeup signal waveform via at least a portion of the wakeup signal bandwidth and a portion of the wakeup signal time duration, wherein the wakeup signal waveform is based at least in part on a chirp signal and on-off keying, or frequency shift keying, or both, of the set of information bits; and
transition from a first state to a second state based at least in part on receiving the wakeup signal waveform.

19. The apparatus of claim 18, wherein the at least one processor is configured to:
transmit or receive a control message indicating a wakeup signal scheme that identifies on-off keying, or frequency shift keying, or both, wherein receiving the wakeup signal waveform is based at least in part on the control message.

20. The apparatus of claim 18, wherein the at least one processor is configured to:
transmit or receive a control message indicating a wakeup signal scheme that identifies the wakeup signal bandwidth and the wakeup signal time duration, and wherein monitoring the wakeup signal bandwidth and the wakeup signal time duration is based at least in part on the control message.

21. (canceled)

22. The apparatus of claim 18, wherein the at least one processor is configured to:
decode the wakeup signal waveform to obtain the set of information bits; and
perform a de-chirp operation, or a filtering operation, or both, wherein decoding the wakeup signal waveform is based at least in part on the de-chirp operation, or the filtering operation, or both.

23. The apparatus of claim 18, wherein the at least one processor is configured to:
decode the wakeup signal waveform to obtain the set of information bits; and
identify a correlation between the wakeup signal waveform and a first type of chirp signal or a second type of chirp signal, wherein decoding the wakeup signal waveform is based at least in part on the correlation.

24. The apparatus of claim 18, wherein:
the wakeup signal waveform occupies the wakeup signal bandwidth and the portion of the wakeup signal time duration, and
the portion of the wakeup signal time duration occupied by the wakeup signal waveform indicates a bit value for a first bit of the set of information bits in accordance with a pattern.

25. The apparatus of claim 18, wherein:
the wakeup signal waveform occupies the portion of the wakeup signal bandwidth and the wakeup signal time duration, and
the portion of the wakeup signal bandwidth occupied by the wakeup signal waveform indicates a bit value for a first bit of the set of information bits in accordance with a pattern.

26. The apparatus of claim 18, wherein:
the wakeup signal waveform occupies the portion of the wakeup signal bandwidth and the portion of the wakeup signal time duration,
the portion of the wakeup signal bandwidth and the portion of the wakeup signal time duration indicate at least a first bit value for a first bit of the set of information bits in accordance with a pattern, and
the portion of the wakeup signal bandwidth and the portion of the wakeup signal time duration occupied by the wakeup signal waveform indicates a second bit value for a second bit of the set of information bits in accordance with the pattern.

27. (canceled)

28. The apparatus of claim 18, wherein a first portion of the wakeup signal waveform occupies the portion of the wakeup signal bandwidth and the portion of the wakeup signal time duration to indicate a first value for a first bit of the set of information bits in accordance with a pattern, and a second portion of the wakeup signal waveform occupies a second portion of the wakeup signal bandwidth and a second portion of the wakeup signal time duration to indicate a second value for a second bit of the set of information bits in accordance with the pattern.

29-30. (canceled)
